(19) United States
(12) Patent Application Publication
(10) Pub. No.: US 2014/0004338 A1
(43) Pub. Date: Jan. 2, 2014

(54) HEAT RAY-SHIELDING MATERIAL

(71) Applicant: FUJIFILM Corporation, Tokyo (JP)

(72) Inventors: Naoharu KIYOTO, Ashigarakami-gun (JP); Osamu SAWANOBORI, Ashigarakami-gun (JP)

(73) Assignee: FUJIFILM Corporation, Tokyo (JP)

(21) Appl. No.: 14/016,926

(22) Filed: Sep. 3, 2013

Related U.S. Application Data
(63) Continuation of application No. PCT/JP2012/051037, filed on Jan. 19, 2012.

(30) Foreign Application Priority Data
Mar. 25, 2011 (JP) 2011-068625
Sep. 20, 2011 (JP) 2011-204456

(51) Int. Cl. G02B 5/20

(52) U.S. Cl. CPC G02B 5/206
USPC 428/328; 428/323

(57) ABSTRACT

Provided is a heat ray-shielding material, including: a metal particle-containing layer including at least one type of metal particles; and an overcoat layer in close contact with at least one surface of the metal particle-containing layer, wherein the metal particles comprise 60% by number or more of substantially hexagonal to substantially circular tabular metal particles, and wherein principal planes of the substantially hexagonal to substantially circular tabular metal particles are plane-oriented within a range from 0° to ±30° on average in relation to one surface of the metal particle-containing layer.

### CROSS-REFERENCE TO RELATED APPLICATION

This application is a continuation application of International Application PCT/JP2012/051037 filed on Jan. 19, 2012 and designated the U.S., the entire contents of which are incorporated herein by reference.

### BACKGROUND OF THE INVENTION

1. Field of the Invention

The present invention relates to a heat ray-shielding material being high in visible light transparency and solar reflectance, being excellent in durability and weather resistance, and being reduced in time-dependent discoloration due to ultraviolet light.

2. Description of the Related Art

Recently, as an energy saving measure for carbon dioxide reduction, heat ray shielding property imparting materials for windows of automobiles and buildings have been developed. From the viewpoint of the heat ray shieldability (solar heat gain coefficient), as compared to heat ray absorption-type materials resulting in re-radiation of the absorbed light to the inside of a room (about ⅓ the absorbed solar radiation energy), heat ray reflection type materials free from such re-radiation are more preferable and various proposals have been made for the latter type materials.

For example, thin metallic Ag films are commonly used as heat ray reflecting materials because of the reflectance thereof; however, thin metallic Ag films reflect radio waves as well as visible light and heat ray, and hence have raised the problems of low visible light transparency and low radio wave transmissivity. For the purpose of increasing the visible light transparency, Low-E glass (for example, a product of Asahi Glass Co., Ltd.) using Ag and ZnO multilayer films are widely adopted for buildings; however, the Low-E glass has raised the problem of low radio wave transmissivity due to the formation of thin metallic Ag film on the glass surface.

For the purpose of solving the foregoing problems, for example, there has been proposed a glass sheet with island-like Ag particles attached thereon to impart radio wave transmissivity to the glass sheet. There has been proposed a glass sheet on which granular Ag is formed by annealing the Ag thin film formed by vapor deposition (see, Japanese Patent (JP-B) No. 3454422). However, in this proposal, the granular Ag is formed by annealing, and hence it is difficult to control, for example, the particle size, the particle shape and the particle area ratio, accordingly it is difficult to control, for example, the reflection wavelength and the band of the heat ray and to improve the visible light transmittance, and consequently, there has been raised a problem such that the shorter wavelength infrared rays, high in solar energy, of the infrared light cannot be sufficiently shielded.

There have also been proposed, as infrared ray shielding filters, filters using Ag tabular particles (see, Japanese Patent Application Laid-Open (JP-A) Nos. 2007-108536, 2007-178915, 2007-138249, 2007-138250 and 2007-154292). However, these proposals are all intended to be applied to plasma display panels (PDPs), and such Ag tabular particles are not controlled in the arrangement thereof, accordingly such filters mainly function as absorbers of infrared rays having wavelengths falling in the infrared region, and do not positively function as materials reflecting heat rays. Accordingly, when an infrared ray shielding filter including such Ag tabular particles is used for heat shielding of direct sunlight, the infrared ray absorbing filter itself is warmed up, and the heat from the filter increases the room temperature so as to be insufficient in the function as an infrared ray shielding material. When the infrared ray shielding filter is attached to a pane of window glass, the temperature increase in the pane of window glass is varied from sunlight-falling areas to sunlight-not-falling areas, and consequently, there is a problem of the occurrence of the so-called heating crack such that the pane of window glass is broken due to the effect of the occurrence of the difference in the expansion coefficient of the filter.

### SUMMARY OF THE INVENTION

The investigation of the presence state of the tabular metal particles in a tabular metal particle-containing layer performed by the present inventors has revealed that when the plane orientation of the tabular particles is too random, the tabular metal particle-containing layer results in poor heat ray shielding. According to the results of laminating the filter using tabular silver particles as the heat ray-shielding material to, for example, a pane of window glass, further performed by the present inventors, it has been revealed that even when the plane orientation of the tabular metal particles is uniform at the time of film formation, the lamination of the filter using tabular silver particles as the heat ray-shielding material to, for example, the pane of window glass sometimes causes non-maintenance of the arrangement of the tabular metal particles so as for the heat ray shielding function to be made poor.

The problem to be solved by the present invention is to solve the conventional foregoing problems and to achieve the following object. Specifically, the problem to be solved by the present invention is to provide a heat ray-shielding material being high in visible light transparency and solar reflectance, being excellent in heat shielding capability and being capable of maintaining the arrangement of the tabular metal particles.

The present inventors made a diligent study for the purpose of solving the foregoing object, and consequently have accomplished the present invention by discovering a material constitution being high in visible light transparency and solar reflectance, being excellent in heat shielding capability and being capable of maintaining the arrangement of the tabular metal particles, wherein the material constitution includes a metal particle-containing layer including at least one type of metal particles; the metal particles include 60% by number or more of substantially hexagonal to substantially circular tabular metal particles; the principal planes of the substantially hexagonal to substantially circular tabular metal particles are plane-oriented within a range from 0° to ±30° in relation to one surface of the metal particle-containing layer; and an overcoat layer is in close contact with at least one surface of the metal particle-containing layer.

The present invention is based on the foregoing findings by the present inventors, and the solution to the foregoing problem is as follows.

The heat ray-shielding material of the present invention includes a metal particle-containing layer including at least one type of metal particles and an overcoat layer in close contact with at least one surface of the metal particle-containing layer, wherein the metal particles include 60% by number or more of substantially hexagonal to substantially circular tabular metal particles, and the principal planes of the substantially hexagonal to substantially circular tabular metal particles are plane-oriented within a range from 0° to ±30° on average in relation to one surface of the metal particle-containing layer.

The present invention can solve the foregoing conventional problems, can achieve the foregoing object, and can provide a heat ray-shielding material being high in visible light transparency and solar reflectance, being excellent in heat shielding capability and being capable of maintaining the arrangement of the tabular metal particles.

### BRIEF DESCRIPTION OF THE DRAWINGS

FIG. 1 is a schematic diagram illustrating an example of the heat ray-shielding material of the present invention.

FIG. 2 is a schematic diagram illustrating another example of the heat ray-shielding material of the present invention.

FIG. 3 is a schematic diagram illustrating yet another example of the heat ray-shielding material of the present invention.

FIG. 4 is a schematic diagram illustrating still yet another example of the heat ray-shielding material of the present invention.

FIG. 5A is a schematic perspective view illustrating an example of the tabular particles included in the heat ray-shielding material of the present invention and illustrates a substantially circular tabular particle.

FIG. 5B is a schematic perspective view illustrating an example of the tabular particles included in the heat ray-shielding material of the present invention and illustrates a tabular particle having a substantially hexagonal shape.

FIG. 6A is a schematic cross-sectional view illustrating an example of the presence state of a metal particle-containing layer including tabular metal particles in the heat ray-shielding material of the present invention.

FIG. 6B is a schematic cross-sectional view illustrating the presence state of a metal particle-containing layer including tabular metal particles in the heat ray-shielding material of the present invention, and showing a view illustrating the angle (θ) formed between the metal particle-containing layer including tabular metal particles (the layer being parallel to the plane of the substrate) and the plane of the substantially hexagonal to substantially circular tabular metal particles.

FIG. 6C is a schematic cross-sectional view illustrating the presence state of a metal particle-containing layer including tabular metal particles in the heat ray-shielding material of the present invention, and showing a view illustrating the presence region of the tabular metal particles of the metal particle-containing layer in the depth direction of the heat ray-shielding material.

FIG. 6D is a schematic cross-sectional view illustrating another example of the presence state of a metal particle-containing layer including tabular metal particles in the heat ray-shielding material of the present invention.

FIG. 6E is a schematic cross-sectional view illustrating yet another example of the presence state of a metal particle-containing layer including tabular metal particles in the heat ray-shielding material of the present invention.

FIG. 6F is a schematic cross-sectional view illustrating still yet another example of the presence state of a metal particle-containing layer including tabular metal particles in the heat ray-shielding material of the present invention.

FIG. 6G is a schematic cross-sectional view illustrating further still yet another example of the presence state of a metal particle-containing layer including tabular metal particles in the heat ray-shielding material of the present invention.

FIG. 7 is a graph showing the transmission spectra observed before and after a weather resistance test for the heat ray-shielding material of Example 1.

FIG. 8 is a graph showing the transmission spectra observed before and after a weather resistance test for the heat ray-shielding material of Example 15.

FIG. 9 is a graph showing the reflection spectrum of the heat ray-shielding material of Example 1.

### DETAILED DESCRIPTION OF THE INVENTION

Hereinafter, the present invention is described in detail.

The description of the constituent features described below is sometimes performed on the basis of the representative embodiments and the specific examples of the present invention, but the present invention is not limited to such embodiments and such specific examples. It is to be noted that the numerical ranges represented by using the word “to” mean the ranges including the numerical values presented before and after the word “to” as the lower limit and the upper limit, respectively.

### (Heat Ray-Shielding Material)

The heat ray-shielding material of the present invention includes a metal particle-containing layer and an overcoat layer, and if necessary, further includes other layers such as an adhesive layer, an ultraviolet light absorption layer, a substrate and a metal oxide particle-containing layer.

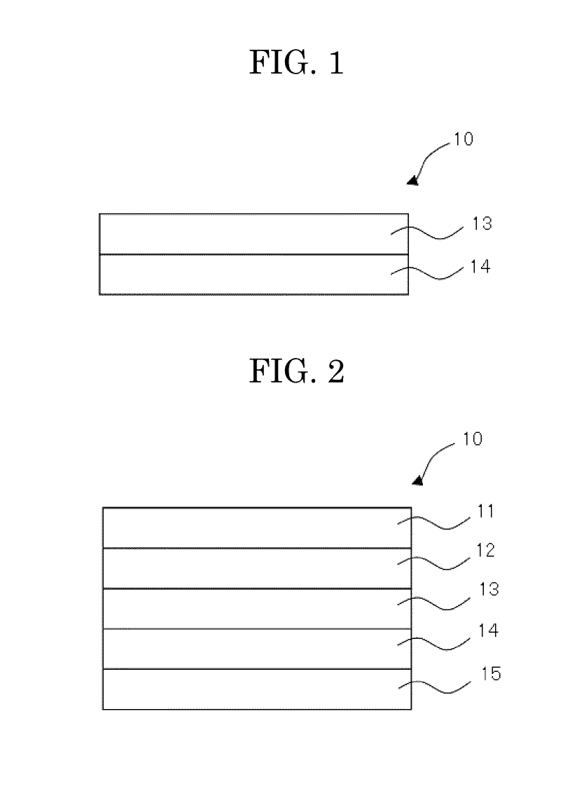

As shown in FIG. 1, examples of the layer structure of the heat ray-shielding material 10 include an aspect of the layer structure including a metal particle-containing layer 14 including at least one type of metal particles and including an overcoat layer 13.

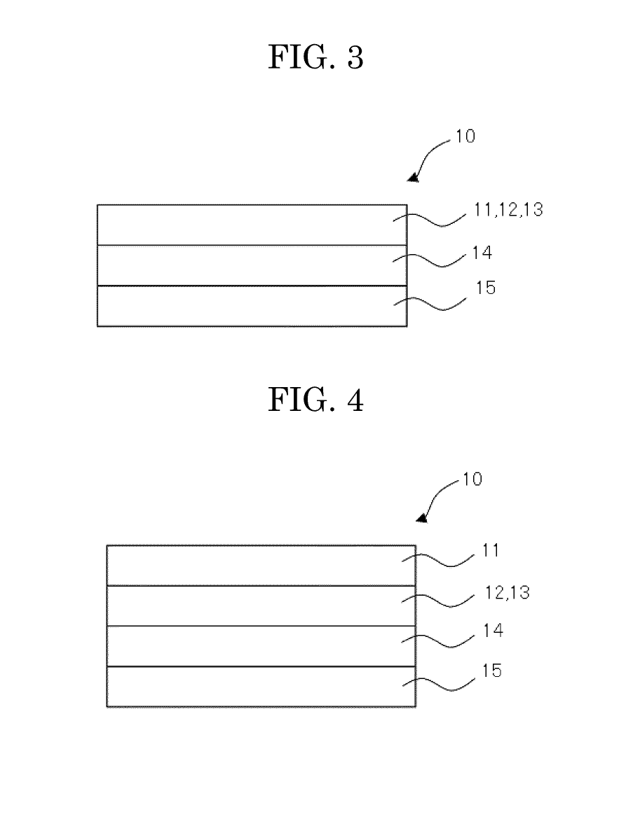

Also, as shown in FIG. 2, examples of the layer structure of the heat ray-shielding material 10 include an aspect of the layer structure including a substrate 15, a metal particle-containing layer 14 on the substrate, an overcoat layer 13 on the metal particle-containing layer, an ultraviolet absorbing layer 12 on the overcoat layer and an adhesive layer 11 on the ultraviolet absorbing layer.

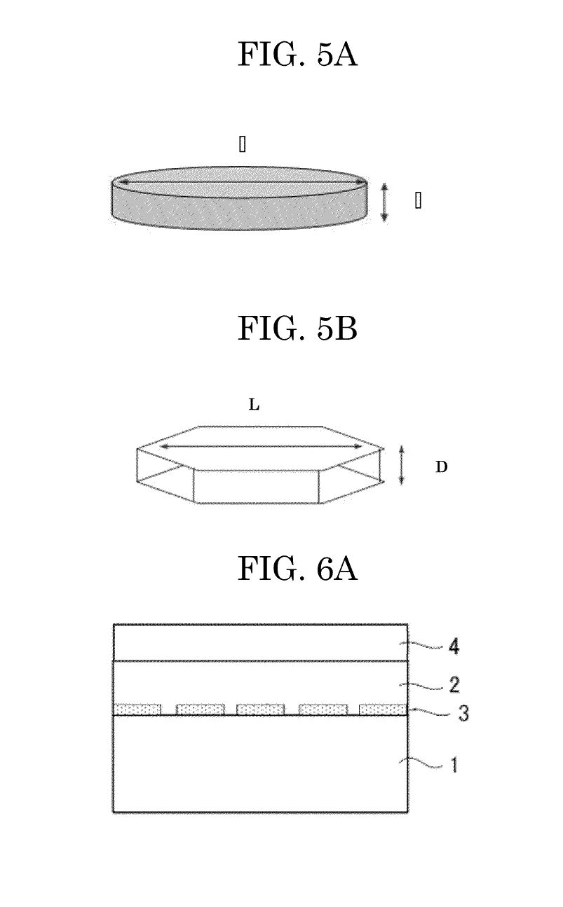

Also, as shown in FIG. 3, examples of the layer structure of the heat ray-shielding material 10 preferably include an aspect of the layer structure including an overcoat layer 13 also functioning as an ultraviolet absorbing layer 12 and an adhesive layer 11, and including a substrate 15, a metal particle-containing layer 14 on the substrate, and the overcoat layer 13, functioning as the ultraviolet absorbing layer 12 and the adhesive layer 11, on the metal particle-containing layer.

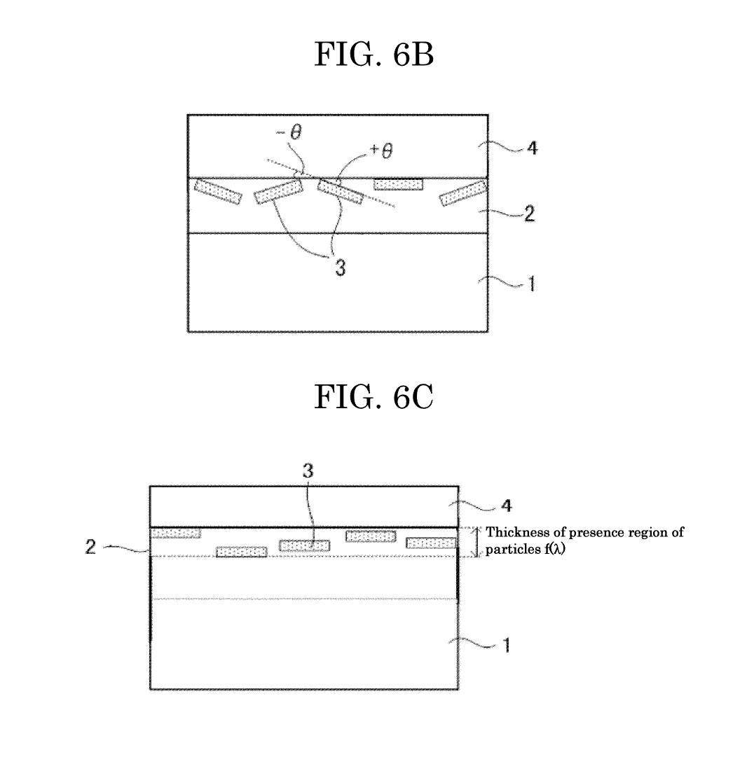

Also, as shown in FIG. 4, examples of the layer structure of the heat ray-shielding material 10 preferably include an aspect of the layer structure including an overcoat layer 13 also functioning as an ultraviolet absorbing layer 12, and including a substrate 15, a metal particle-containing layer 14 on the substrate, an overcoat layer 13, functioning as an ultraviolet absorbing layer 12, on the metal particle-containing layer, and an adhesive layer 11 on the overcoat layer 13 also functioning as the ultraviolet absorbing layer 12.

In the heat ray-shielding material of the present invention, as shown in FIG. 1 to FIG. 4, the provision of the overcoat layer 13 appropriately protects the substantially hexagonal to substantially circular tabular metal particles included in the metal particle-containing layer, and can solve the problems such as the oxidation/sulfidation and abrasion of the tabular metal particles caused by the mass transfer, the contaminations in the production step due to the exfoliation of the tabular metal particles, and the disturbance of the arrangement of the tabular metal particles at the time of applying another layer or other layers. The effect of the provision of the overcoat layer 13 is particularly remarkable when the tabular metal particles are segregated on the surface on the side of the overcoat layer of the metal particle-containing layer.

### <Metal Particle-Containing Layer>

The metal particle-containing layer is a layer including at least one type of metal particles, and is not particularly limited and can be appropriately selected according to the intended purpose as long as the metal particles include 60% by number or more of the substantially hexagonal to substantially circular tabular metal particles, the principal planes of the substantially hexagonal to substantially circular tabular metal particles are plane-oriented within a range from 0° to ±30° on average in relation to one surface of the metal particle-containing layer.

Without adhering to any theory and with the heat ray-shielding material of the present invention without being limited to the following production method, operations such as the addition of a specific latex at the time of producing the metal particle-containing layer allows the tabular metal particles to be segregated on one surface of the metal particle-containing layer.

### —Metal Particles—

The metal particles are not particularly limited and can be appropriately selected according to the intended purpose as long as the metal particles include 60% by number or more of the substantially hexagonal to substantially circular tabular metal particles, and the principal planes of the substantially hexagonal to substantially circular tabular metal particles are plane-oriented within a range from 0° to ±30° on average in relation to one surface of the metal particle-containing layer. With d representing the thickness of the metal particle-containing layer, 80% by number or more of the substantially hexagonal to substantially circular tabular metal particles are present preferably within a range of d/2 and more preferably within a range of d/3 from the surface of the metal particle-containing layer.

In the metal particle-containing layer, the presence form of the substantially hexagonal to substantially circular tabular metal particles is such that the substantially hexagonal to substantially circular tabular metal particles are plane-oriented within a range from 0° to ±30° on average in relation to one surface of the metal particle-containing layer (in relation to the surface of the substrate when the heat ray-shielding material of the present invention includes a substrate).

In the substantially hexagonal to substantially circular tabular metal particles, with d representing the thickness of the metal particle-containing layer, 80% by number or more of the substantially hexagonal to substantially circular tabular metal particles are present preferably within a range of d/2 and more preferably within a range of d/3 from the surface of the metal particle-containing layer.

One surface of the metal particle-containing layer is preferably a flat plane. When the metal particle-containing layer of the heat ray-shielding material of the present invention includes a substrate as a temporary support, one surface of the metal particle-containing layer as well as the surface of the substrate is preferably a substantially flat plane. Here, the heat ray-shielding material may include the temporary support or may include no temporary support.

The size of the metal particles is not particularly limited, and can be appropriately selected according to the intended purpose; for example, the metal particles may have an average particle diameter of 500 nm or less.

The material for the metal particles is not particularly limited, and can be appropriately selected according to the intended purpose; however, from the viewpoint of the high reflectance of heat ray (near-infrared ray), for example, silver, gold, aluminum, copper, rhodium, nickel and platinum are preferable.

### —Tabular Metal Particles—

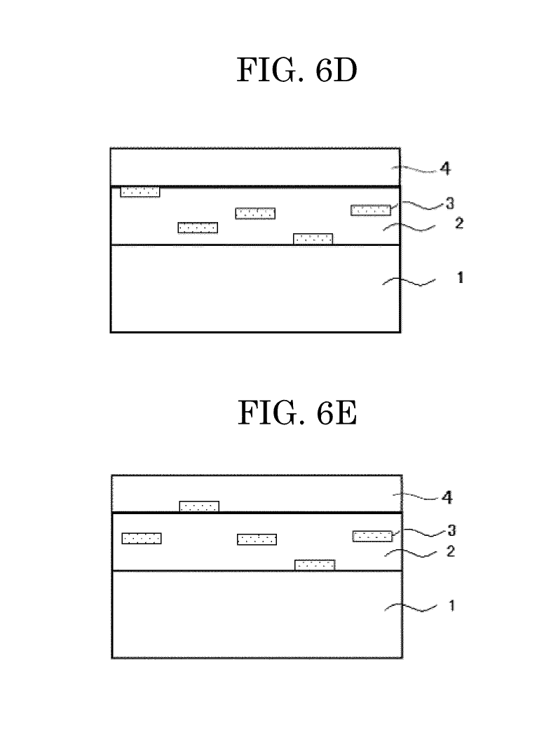

The tabular metal particles are not particularly limited as long as the tabular metal particles are each a particle including two principal planes (see FIG. 5A and FIG. 5B), and can be appropriately selected according to the intended purpose; examples of the shapes of the tabular metal particles include a substantially hexagonal tabular shape, a substantially circular tabular shape and a substantially triangular tabular shape. Among these, from the viewpoint of high visible light transmittance, the shapes of the tabular metal particles are preferably a substantially hexagonal or higher polygonal to substantially circular tabular shape, and particularly preferably a substantially hexagonal shape or a substantially circular tabular shape.

It is to be noted that in FIG. 5A and FIG. 5B, L represents a diameter and D represents a thickness.

In the present description, the substantially circular tabular shape means a shape in which when the irregularities equal to or less than 10% of the average equivalent circle diameter of the below-described tabular silver particle are neglected, the number of the sides having a length of 50% or more of the average equivalent circle diameter is 0 per one tabular silver particle. The substantially circular tabular metal particles are not particularly limited, and can be appropriately selected according to the intended purpose as long as when the tabular metal particles are observed from above the principal plane with a transmission electron microscope (TEM), the tabular metal particles are free from edges and round in shape.

In the present description, the substantially hexagonal shape means a shape in which when the irregularities equal to or less than 10% of the average equivalent circle diameter of the below-described tabular silver particle are neglected, the number of the sides having a length of 20% or more of the average equivalent circle diameter is 6 per one tabular silver particle. Other polygons may also be defined similarly. The tabular metal particles having a substantially hexagonal shape are not particularly limited, and can be appropriately selected according to the intended purpose as long as when the tabular metal particles are observed from above the principal plane with a transmission electron microscope (TEM), the tabular metal particles are substantially hexagonal in shape; for example, although the hexagonal shape may have acute angle edges or obtuse angle edges, the hexagonal shape having obtuse angle edges is preferable from the viewpoint of being capable of alleviating the absorption in the visible light. The degree of obtuseness of the edges is not particularly limited, and can be appropriately selected according to the intended purpose.

The material for the tabular metal particles is not particularly limited, and the same material as for the foregoing metal particles can be appropriately selected according to the intended purpose. The tabular metal particles preferably include at least silver.

Of the metal particles present in the metal particle-containing layer, the substantially hexagonal to substantially circular tabular metal particles account for, in relation to the total number of the metal particles, 60% by number or more, preferably 65% by number or more and more preferably 70% by number or more. When the proportion of the tabular metal particles is less than 60% by number, the visible light transmittance is sometimes decreased.

### [Plane Orientation]

In the heat ray-shielding material of the present invention, the principal planes of the substantially hexagonal to substantially circular tabular metal particles are plane-oriented within a range from 0° to ±30° on average, preferably plane-oriented within a range from 0° to ±20° on average and particularly preferably plane-oriented within a range from 0° to ±5° on average in relation to one surface of the metal particle-containing layer (in relation to the surface of the substrate when the heat ray-shielding material of the present invention includes a substrate).

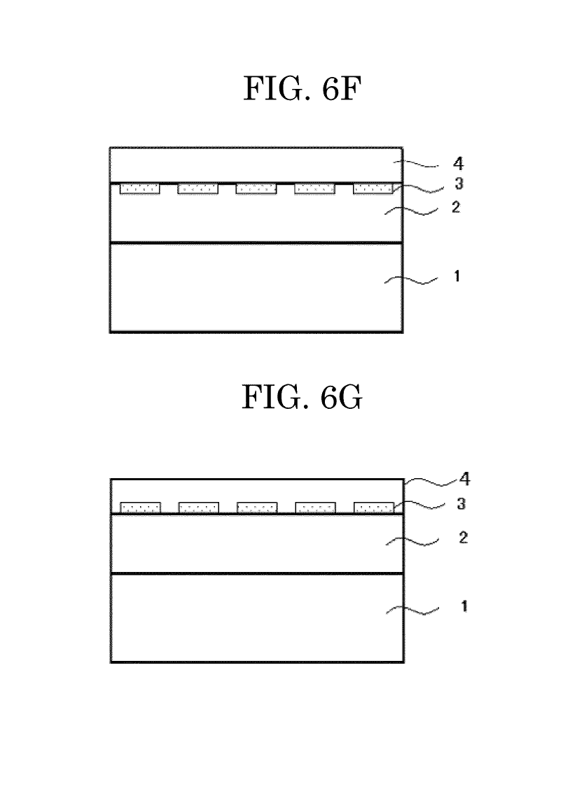

The presence state of the tabular metal particles is not particularly limited, and can be appropriately selected according to the intended purpose; however, the presence state of the tabular metal particles is preferably such that the tabular metal particles are arranged as shown in FIG. 6F or FIG. 6G described below.

FIG. 6A to FIG. 6G are each a schematic cross-sectional view illustrating the presence state of the metal particle-containing layer including tabular metal particles in the heat ray-shielding material of the present invention. FIG. 6D to FIG. 6F each represent the presence state of the tabular metal particles 3 in the metal particle-containing layer 2. FIG. 6B is a view illustrating the angle (±θ) formed between a plane of the substrate 1 and the planes of the tabular metal particles 3. FIG. 6C illustrates the presence region of the metal particle-containing layer 2 in the depth direction of the heat ray-shielding material.

In FIG. 6B, the angle (±θ) formed between the surface of the substrate 1 and the principal plane or the extended line of the principal plane of the tabular metal particle 3 corresponds to the predetermined range of the plane orientation. Specifically, the plane orientation means the state in which the inclination angle (±θ) shown in FIG. 6B is small when the cross-section of the heat ray-shielding material is observed; in particular, FIG. 6F shows the state in which the surface of the substrate 1 and each of the principal planes of the tabular metal particles 3 are in contact with each other, namely, the state in which θ is 0°. When the angle of the plane orientation of the principal plane of the tabular metal particle 3 in relation to the surface of the substrate 1, namely, θ in FIG. 6B exceeds ±30°, the reflectance of the heat ray-shielding material for the predetermined wavelength (for example, from the longer wavelength side of the visible light region to the near-infrared light region) is decreased.

The evaluation as to whether or not the principal planes of the tabular metal particles in relation to one surface of the metal particle-containing layer (for example, in relation to the surface of the substrate when the heat ray-shielding material of the present invention includes a substrate) is not particularly limited and can be appropriately selected according to the intended purpose; for example, the evaluation may be based on an evaluation method in which an appropriate section of the cross-section is prepared, and the metal particle-containing layer (for example, the substrate when the heat ray-shielding material includes a substrate) and the tabular metal particles in the section are observed for evaluation. Specifically, examples of the evaluation method include a method in which the heat ray-shielding material is cut with a microtome or a focused ion beam (FIB) to prepare a cross-section sample or a cross-section slice sample, the resulting sample is observed with various microscopes (for example, a field emission scanning electron microscope (FE-SEM)) to obtain an image or images, and the evaluation is performed on the basis of the obtained image or images.

When in the heat ray-shielding material, the binder coating the tabular metal particles is swollen with water, a cross-section sample or a cross-section slice sample may be prepared by cutting a sample of the heat ray-shielding material in a state of being frozen with liquid nitrogen by using a diamond cutter mounted to a microtome. Alternatively, when in the heat ray-shielding material, the binder coating the tabular metal particles is not swollen with water, the cross-section sample or the cross-section slice sample may be prepared.

The observation of the cross-section sample or the cross-section slice sample prepared as described above is not particularly limited and can be appropriately selected according to the intended purpose as long as the observation can verify whether or not the principal planes of the tabular metal particles are plane-oriented in relation to one surface (for example, the surface of the substrate when the heat ray-shielding material includes a substrate) of the metal particle-containing layer in the sample; examples of such an observation include the observations using microscopes such as a FE-SEM, a TEM and an optical microscope. The observation may be performed with a FE-SEM in the case of the cross-section sample, and with a TEM in the case of the cross-section slice sample. When the evaluation is performed with a FE-SEM, the FE-SEM preferably has a spatial resolution capable of clearly determining the shapes and the inclination angles (±θ in FIG. 6B) of the tabular metal particles.

### [Average Particle Diameter (Average Equivalent Circle Diameter) and Particle Size Distribution of Average Particle Diameter (Average Equivalent Circle Diameter)]

The average particle diameter (average equivalent circle diameter) of the tabular metal particles is not particularly limited, and can be appropriately selected according to the intended purpose, but is preferably 70 nm to 500 nm and more preferably 100 nm to 400 nm. When the average particle diameter (average equivalent circle diameter) is less than 70 nm, the contribution of the absorption of the tabular metal particles becomes larger than the reflection, and hence no sufficient heat ray reflection capability is sometimes obtained; when the average particle diameter (average equivalent circle diameter) exceeds 500 nm, the haze (scattering) becomes large, and hence the transparency of the substrate is sometimes impaired.

Here, the average particle diameter (average equivalent circle diameter) means an average value of the principal plane diameters (maximum lengths) of the 200 tabular particles randomly selected from the images obtained by the observation of the particles with a TEM.

In the metal particle-containing layer, two or more types of metal particles different in the average particle diameter (average equivalent circle diameter) can be included; in such a case, the metal particles may have two or more peaks of the average particle diameter (average equivalent circle diameter), namely, two or more average particle diameters (average equivalent circle diameters).

In the heat ray-shielding material of the present invention, the coefficient of variation in the particle size distribution of the tabular metal particles is preferably 30% or less and more preferably 20% or less. When the coefficient of variation exceeds 30%, the heat ray reflection wavelength region in the heat ray-shielding material sometimes becomes broad.

The coefficient of variation in the particle size distribution of the tabular metal particles is, for example, the value (%) obtained by dividing the standard deviation of the particle size distribution obtained by plotting in the distribution range of the particle diameters of the 200 tabular metal particles used for the derivation of the average value obtained as described above, by the average value (average particle diameter (average equivalent circle diameter)) of the principal plane diameters (maximum lengths) obtained as described above.

### [Aspect Ratio]

The aspect ratio of the tabular metal particles is not particularly limited, and can be appropriately selected according to the intended purpose, but is preferably 8 to 40 and more preferably 10 to 35, from the viewpoint of the increase of the reflectance in the infrared light region of the wavelengths of 780 nm to 1,800 nm. When the aspect ratio is less than 8, the reflection wavelength becomes shorter than 780 nm, and when the aspect ratio exceeds 40, the reflection wavelength becomes longer than 1,800 nm, and no sufficient heat ray reflection capability is sometimes obtained.

The aspect ratio means a value obtained by dividing the average particle diameter (average equivalent circle diameter) of the tabular metal particles by the average particle thickness of the tabular metal particles. The particle thickness corresponds, for example, as shown in FIG. 5A and FIG. 5B, to the distance between the principal planes of the tabular metal particle, and can be measured with an atomic force microscope (AFM). The average particle thickness means an average value of the distances between the principal planes (particle thickness values) of the 200 tabular particles randomly selected from the images obtained by the observation of the particles with an AFM.

The measurement method of the particle thickness with an AFM is not particularly limited, and can be appropriately selected according to the intended purpose; examples of such a measurement method include a method in which a particle dispersion including the tabular metal particles is dropwise placed on a glass substrate and dried, and the thickness of each of the single particles is measured. The thickness of the tabular metal particles is preferably 5 nm to 20 nm.

### [Presence Range of Tabular Metal Particle]

In the heat ray-shielding material of the present invention, 80% by number or more of the substantially hexagonal to substantially circular tabular metal particles are present preferably within a range of d/2 and more preferably within a range of d/3 from the surface of the metal particle-containing layer, and more preferably 60% by number or more of the substantially hexagonal to substantially circular tabular metal particles are exposed on one surface of the metal particle-containing layer.

The presence distribution of the tabular metal particles in the metal particle-containing layer can be measured, for example, from the image obtained by performing the SEM observation of a cross-section sample of the heat ray-shielding material.

The plasmon resonance wavelength λ of the metal constituting the tabular metal particles in the metal particle-containing layer is not particularly limited, and can be appropriately selected according to the intended purpose, but is preferably 400 nm to 2,500 nm from the viewpoint of imparting the heat ray reflection capability, and is preferably 700 nm to 2,500 nm from the viewpoint of imparting the visible light transmittance.

The medium in the metal particle-containing layer is not particularly limited, and can be appropriately selected according to the intended purpose; examples of such a medium include: polymers such as polyvinyl acetal resin, polyvinyl alcohol resin, polyvinyl butyral resin, polyacrylate resin, polymethyl methacrylate resin, polycarbonate resin, polyvinyl chloride resin, saturated polyester resin, polyurethane resin, and natural polymers such as gelatin and cellulose; and inorganic substances such as silicon dioxide and aluminum oxide.

The refractive index of the medium is preferably 1.4 to 1.7.

### [Area Ratio of Tabular Metal Particle]

The area ratio [(B/A)×100) of the total value B of the areas of the tabular metal particles to the area A of the substrate as specified when the heat ray-shielding material is viewed from above (the total projected area A of the metal particle-containing layer when viewed from above the metal particle-containing layer) is preferably 15% or more and more preferably 20% or more. When the area ratio is less than 15%, the maximum reflectance of the heat ray is decreased, and no sufficient shielding effect is sometimes obtained.

The area ratio can be measured by image processing of the image obtained by the SEM observation of the substrate of the heat ray-shielding material from above the substrate, and the image obtained by the AFM (atomic force microscope) observation.

### [Average Inter-Particle Distance of Tabular Metal Particles]

The average inter-particle distance between the horizontally adjacent tabular metal particles in the metal particle-containing layer is preferably 1/10 or more the average particle diameter of the tabular metal particles from the viewpoint of the visible light transmittance and the maximum reflectance of the heat ray.

When the average horizontal inter-particle distance between the tabular metal particles is less than 1/10 the average particle diameter of the tabular metal particles, the maximum reflectance of the heat ray is decreased. The average horizontal inter-particle distance is preferably nonuniform (random) from the viewpoint of the visible light transmittance. The average horizontal inter-particle distance is not random, that is to say uniform, the absorption of visible light occurs and the transmittance is sometimes decreased.

The average horizontal inter-particle distance of the tabular metal particles means an average value of the distances between the horizontally adjacent particles. The statement that the average inter-particle distance is random means that in the case where a SEM image including 100 or more tabular metal particles is binarized, when the two-dimensional autocorrelation of the brightness values is derived, the autocorrelation does not have significant maximum points other than the origin.

### [Layer Structure/Thickness of Metal Particle-Containing Layer]

In the heat ray-shielding material of the present invention, as shown in FIG. 6A to FIG. 6G, the tabular metal particles are arranged in the form of a metal particle-containing layer including the tabular metal particles.

The metal particle-containing layer may be formed with a single layer as shown in FIG. 6A to FIG. 6G, or may also be formed with a plurality of metal particle-containing layers. When the metal particle-containing layer is formed with a plurality of metal particle-containing layers, it is possible to impart the heat shielding capability corresponding to the wavelength band to which the heat shielding capability is intended to be imparted.

The thickness of the metal particle-containing layer is preferably 20 nm to 80 nm.

The thickness of each layer of the metal particle-containing layer can be measured, for example, by the image obtained by the SEM observation of the cross-section sample of the heat ray-shielding material.

### [Method for Synthesizing Tabular Metal Particles]

The method for synthesizing the tabular metal particles is not particularly limited and can be can be appropriately selected according to the intended purpose as long as the synthesis method can synthesize the substantially hexagonal to substantially circular tabular shape; examples of such a synthesis method include liquid phase methods such as a chemical reduction method, a photochemical reduction method and a electrochemical reduction method. Among these methods, from the viewpoint of the shape controllability and the size controllability, the liquid phase methods such as a chemical reduction method and a photochemical reduction method are particularly preferable. After the synthesis of tabular metal particles having a hexagonal shape or a trigonal shape, the tabular metal particles are subjected to treatment such as an etching treatment with a dissolution species dissolving silver such as nitric acid or sodium sulfite or an aging treatment based on heating so as to make obtuse the edges of the tabular metal particles having a hexagonal shape or a trigonal shape, and thus substantially hexagonal to substantially circular tabular metal particles may also be obtained.

As the method for synthesizing the tabular metal particles, in addition to the foregoing synthesis methods, after seed crystals are beforehand fixed on the surface of a transparent substrate such as a film or a glass plate, metal (for example, Ag) particles may be crystal grown in a tabular shape.

In the heat ray-shielding material of the present invention, the tabular metal particles may be subjected to further treatments for the purpose of imparting intended properties to the tabular metal particles. The further treatments are not particularly limited, and can be appropriately selected according to the intended purpose; examples of such further treatments include the formation of a high refractive index shell layer and the addition of various additives such as a dispersant and an antioxidant.

### —Formation of High Refractive Index Shell Layer—

The tabular metal particles may be coated with a high refractive index material having high visible light region transparency for the purpose of further increasing the visible light region transparency.

The high refractive index material is not particularly limited, and can be appropriately selected according to the intended purpose; examples of such a high refractive index material include TiOₓ, BaTiO₃, ZnO, SnO₂, ZrO₂ and NbOₓ.

The coating method is not particularly limited, can be appropriately selected according to the intended purpose, and may be, for example, a method in which a TiOₓ layer is formed on the surface of the tabular metal particles of silver by hydrolyzing tetrabutoxy titanium, as reported in Langmuir, 2000, Vol. 16, pp. 2731 to 2735.

In the case where it is difficult to directly form a high refractive index metal oxide layer shell on the tabular metal particles, after the tabular metal particles are synthesized as described above, appropriately a shell layer of SiO₂ or a polymer is formed and further, the metal oxide layer may be formed on the shell layer. When TiOₓ is used as a material for the high refractive index metal oxide layer, because TiOₓ has photocatalytic activity, there is a fear of degradation of the matrix for dispersing the tabular metal particles, and hence, according to the intended purpose, after a TiOₓ layer is formed on the tabular metal particles, a SiO₂ layer may be appropriately formed.

### —Addition of Various Additives—

In the heat ray-shielding material of the present invention, the tabular metal particles may adsorb an antioxidant such as mercaptotetrazole or ascorbic acid for the purpose of preventing the oxidation of the metal such as silver constituting the tabular metal particles. For the purpose of preventing the oxidation, a sacrificial oxidation layer such as a Ni layer may be formed on the surface of the tabular metal particles. For the purpose of blocking oxygen, the tabular metal particles may be coated with a film of a metal oxide such as SiO₂.

To the tabular metal particles, for the purpose of imparting dispersibility to the tabular metal particles, for example, dispersants such as low molecular weight dispersants and high molecular weight dispersants including at least any one of the elements N, S and P, such as quaternary ammonium salts and amines may be added.

### <<Overcoat Layer>>

In the heat ray-shielding material of the present invention, for the purpose of preventing the oxidation/sulfidation of the tabular metal particles due to mass transfer and imparting scratch resistance to the tabular metal particles, the heat ray-shielding material of the present invention preferably includes an overcoat layer in close contact with the surface of the metal particle-containing layer at the side where the substantially hexagonal to substantially circular tabular metal particles are exposed. The heat ray-shielding material of the present invention preferably includes an overcoat layer between the metal particle-containing layer and the ultraviolet absorbing layer. The heat ray-shielding material of the present invention preferably includes an overcoat layer, in the case where the tabular metal particles are unevenly distributed close to the surface of the metal particle-containing layer, the heat ray-shielding material preferably includes an overcoat layer for the purpose of preventing the problems such as the contaminations in the production step due to the exfoliation of the tabular metal particles and the disturbance of the arrangement of the tabular metal particles at the time of applying another layer or other layers.

The overcoat layer is not particularly limited, can be appropriately selected according to the intended purpose, and includes, for example, a binder, a matte agent and a surfactant, and if necessary, other components.

The binder is not particularly limited, can be appropriately selected according to the intended purpose; examples of the binder include thermosetting or photocurable resins such as acrylic resin, silicone-based resin, melamine-based resin, urethane-based resin, alkyd-based resin and fluorine-based resin. The binders quoted as examples for the ultraviolet absorbing layer can also be used. The function as the overcoat layer may also be imparted to the ultraviolet absorbing layer.

The thickness of the overcoat layer is preferably 0.01 μm to 1,000 μm, more preferably 0.02 μm to 500 μm, particularly preferably 0.1 μm to 10 μm and more particularly preferably 0.2 μm to 5 μm.

### <Ultraviolet Absorbing Layer>

The ultraviolet absorbing layer is not particularly limited and can be appropriately selected according to the intended purpose, as long as the ultraviolet absorbing layer is a layer including at least an ultraviolet absorber; the ultraviolet absorbing layer may be an adhesive layer and alternatively may be an layer (for example, a substrate, or an intermediate layer other than the substrate) between the adhesive layer and the metal particle-containing layer. In all cases, the ultraviolet absorbing layer is preferably disposed on the side irradiated with sunlight in relation to the metal particle-containing layer.

When the ultraviolet absorbing layer forms an intermediate layer other than either of an adhesive layer and a substrate, the ultraviolet absorbing layer includes at least an ultraviolet absorber, and if necessary, further includes other components such as a binder. The heat ray-shielding material of the present invention preferably includes the ultraviolet absorbing layer on the side of the surface of the metal particle-containing layer on which the substantially hexagonal to substantially circular tabular metal particles are exposed. In such a case, the below-described overcoat layer and ultraviolet absorbing layer may be identical to or different from each other. Specifically, in the heat ray-shielding material of the present invention, the overcoat layer is preferably a layer between the ultraviolet absorbing layer and the metal particle-containing layer, and alternatively, the overcoat layer is also preferably the ultraviolet absorbing layer.

### —Ultraviolet Absorber—

The ultraviolet absorber is not particularly limited, and can be appropriately selected according to the intended purpose; examples of such an ultraviolet absorber include: benzophenone-based ultraviolet absorbers, benzotriazole-based ultraviolet absorbers, triazine-based ultraviolet absorbers, salicylate-based ultraviolet absorbers and cyanoacrylate-based ultraviolet absorbers. These may be used each alone or in combinations of two or more thereof.

The benzophenone-based ultraviolet absorbers are not particularly limited and can be appropriately selected according to the intended purpose; examples of the benzophenone-based ultraviolet absorbers include 2,4-hydroxy-4-methoxy-5-sulfobenzophenone.

The benzotriazole-based ultraviolet absorbers are not particularly limited and can be appropriately selected according to the intended purpose; examples of the benzotriazole-based ultraviolet absorbers include
2-(5-chloro-2H-benzotriazol-2-yl)-4-methyl-6-tert-butylphenol (Tinuvin 326),
2-(2-hydroxy-5-methylphenyl)benzotriazole,
2-(2-hydroxy-5-tertiarybutyllphenyl)benzotriazole and
2-(2-hydroxy-3-5-ditertiarybutyllphenyl)-5-chlorobenzotriazole.

The triazine-based ultraviolet absorbers are not particularly limited and can be appropriately selected according to the intended purpose; examples of the triazine-based ultraviolet absorbers include mono(hydroxyphenyl)triazine compounds, bis(hydroxyphenyl)triazine compounds and tris(hydroxyphenyl)triazine compounds.

Examples of the mono-(hydroxyphenyl)triazine compounds include
2-[4-[(2-hydroxy-3-dodecyloxypropyl)oxy]-2-hydroxyphenyl]-4,6-bis(2,4-dimethylphenyl)-1,3,5-triazine,
2-[4-[(2-hydroxy-3-tridecyloxypropynoxy]-2-hydroxyphenyl]-4,6-bis(2,4-dimethylphenyl)-1,3,5-triazine,
2-(2,4-dihydroxyphenyl)-4,6-bis(2,4-dimethylphenyl)-1,3,5-triazine,
2-(2-hydroxy-4-isooctyloxyphenyl)-4,6-bis(2,4-dimethylphenyl)-1,3,5-triazine and
2-(2-hydroxy-4-dodecyloxyphenyl)-4,6-bis(2,4-dimethylphenyl)-1,3,5-triazine.

Examples of the bis(hydroxyphenyl)triazine compounds include
2,4-bis(2-hydroxy-4-propyloxyphenyl)-6-(2,4-dimethylphenyl)-1,3,5-triazine,
2,4-bis(2-hydroxy-3-methyl-4-propyloxyphenyl)-6-(4-methylphenyl)-1,3,5-triazine,
2,4-bis(2-hydroxy-3-methyl-4-hexyloxyphenyl)-6-(2,4-dimethylphenyl)-1,3,5-triazine and
2-phenyl-4,6-bis[2-hydroxy-4-[3-(methoxyheptaethoxy)-2-hydroxypropyloxy]phenyl]-1,3,5-triazine.

Examples of the tris(hydroxyphenyl)triazine compounds include
2,4-bis(2-hydroxy-4-butoxyphenyl)-6-(2,4-dibutoxyphenyl)-1,3,5-triazine,
2,4,6-tris(2-hydroxy-4-octyloxyphenyl)-1,3,5-triazine,
2,4,6-tris[2-hydroxy-4-(3-butoxy-2-hydroxypropyloxy)phenyl]-1,3,5-triazine,
2,4-bis[2-hydroxy-4-[1-(isooctyloxycarbonyl)ethoxy]phenyl]-6-(2,4-dihydroxyphenyl-1,3,5-triazine,
2,4,6-tris[2-hydroxy-4-[1-(isooctyloxycarbonyl)ethoxy]phenyl]-1,3,5-triazine and
2,4-bis[2-hydroxy-4-[1-(isooctyloxycarbonyl)ethoxy]phenyl]-6-[2,4-bis[1-(isooctyloxycarbonyflethoxy]phenyl]-6-[2,4-bis[1-(isooctyloxycarbonyl)ethoxy]phenyl]-1,3,5-triazine.

The salicylate-based ultraviolet absorbers are not particularly limited and can be appropriately selected according to the intended purpose; examples of the salicylate-based ultraviolet absorbers include phenyl salicylate, p-tert-butylphenyl salicylate, p-octylphenyl salicylate and 2-ethylhexyl salicylate.

The cyanoacrylate-based ultraviolet absorbers are not particularly limited and can be appropriately selected according to the intended purpose; examples of the cyanoacrylate-based ultraviolet absorbers include 2-ethylhexyl-2-cyano-3,3-diphenyl acrylate and ethyl-2-cyano-3,3-diphenyl acrylate.

### —Binder—

The binder is not particularly limited and can be appropriately selected according to the intended purpose; however, the binder is preferably high in visible light transparency and solar transparency, and examples of such a binder include acrylic resin, polyvinyl butyral and polyvinyl alcohol. When the binder absorbs heat ray, the reflection effect due to the tabular metal particles is reduced, and hence for the ultraviolet absorbing layer formed between the heat ray source and the metal tabular particles, it is preferable to select such materials that have no absorption in the region from 450 nm to 1,500 nm, or alternatively to reduce the thickness of the ultraviolet absorbing layer.

The thickness of the ultraviolet absorbing layer is preferably 0.01 μm to 1,000 μm and more preferably 0.02 μm to 500 μm. When the thickness is less than 0.01 μm, the absorption of ultraviolet light sometimes becomes insufficient, and when the thickness exceeds 1,000 μm, the transmittance of visible light is sometimes decreased.

The content of the ultraviolet absorbing layer is different depending on the ultraviolet absorbing layer to be used and cannot be unconditionally specified; it is preferable to appropriately select the content giving the intended ultraviolet light transmittance in the heat ray-shielding material of the present invention.

The ultraviolet light transmittance is preferably 5% or less and more preferably 2% or less. When the ultraviolet light transmittance exceeds 5%, the hue of the tabular metal particle layer is sometimes changed due to the ultraviolet light in the sunlight.

### <Other Layers>

### <<Adhesive Layer>>

The heat ray-shielding material of the present invention preferably includes an adhesive layer. The adhesive layer may be an adhesive layer having the function of the ultraviolet absorbing layer, or alternatively may be an adhesive layer not including the ultraviolet absorber.

The materials usable for the formation of the adhesive layer is not particularly limited and can be appropriately selected according to the intended purpose; examples of such materials include polyvinyl butyral (PVB) resin, acrylic resin, styrene/acryl resin, urethane resin, polyester resin and silicone resin. These resins may be used each alone or in combinations of two or more thereof. The adhesive layer composed of these materials can be formed by application.

To the adhesive layer, for example, an antistatic agent, a lubricant and a blocking preventing agent may be further added.

The thickness of the adhesive layer is preferably 0.1 μm to 10 μm.

### <<Substrate>>

The substrate is not particularly limited and can be appropriately selected according to the intended purpose as long as the substrate is an optically transparent substrate; examples of such a substrate include a substrate having a visible light transmittance of 70% or more or preferably 80% or more, and a substrate having a high transmittance in the near infrared ray region.

For the substrate, for example, the shape, structure, size and material thereof are not particularly limited and can be appropriately selected according to the intended purpose. Examples of the shape include a flat plate shape, the structure may be a single layer structure or a layered structure, and the size can be appropriately selected according to the size of the heat ray-shielding material.

The material of the substrate is not particularly limited and can be appropriately selected according to the intended purpose; examples of such a material include: polyolefin-based resins such as polyethylene, polypropylene, poly4-methylpentene-1 and polybutene-1; polyester-based resins such as polyethylene terephthalate and polyethylene naphthalate; polycarbonate-based resin; polyvinyl chloride-based resin; polyphenylene sulfide-based resin; polyether sulfone-based resin; polyethylene sulfide-based resin; polyphenylene ether-based resin; styrene-based resin; acrylic resin; polyamide-based resin; polyimide-based resin; and cellulose-based resins such as cellulose acetate, and examples of the substrate include films made of these resins or layered film made of these films. Among these films, in particular, polyethylene terephthalate film is preferable.

The thickness of the substrate film is not particularly limited, can be appropriately selected according to the intended use of the solar shielding film, and is usually about 10 μm to 500 μm, preferably 12 μm to 300 μm and more preferably 16 μm to 125 μm.

### <<Metal Oxide Particle-Containing Layer>>

The heat ray-shielding material of the present invention preferably further includes a metal oxide particle-containing layer including at least one type of metal oxide particles as a layer absorbing long-wavelength infrared ray from the viewpoint of the balance between the heat ray shielding and the production cost. The heat ray-shielding material of the present invention preferably includes the metal oxide particle-containing layer on the side of the surface of the metal particle-containing layer opposite to the surface of the metal particle-containing layer on which the substantially hexagonal to substantially circular tabular metal particles are exposed. In this case, for example, the metal oxide particle-containing layer and the metal oxide particle-containing layer may be laminated on each other through the intermediary of the substrate. When the heat ray-shielding material of the present invention is disposed in such a way that the tabular metal particle-containing layer is on the incidence side of the heat ray such as sunlight, after a fraction (or possibly the whole) of the heat ray is reflected in the tabular metal particle-containing layer, a fraction of the heat ray is absorbed in the metal oxide-containing layer; accordingly, it is possible to reduce the quantity of heat as the sum of the quantity of heat directly received inside the heat ray-shielding material due to the heat ray transmitting through the heat ray-shielding material without being absorbed in the metal oxide-containing layer and the quantity of heat absorbed in the metal oxide-containing layer 2 of the heat ray-shielding material and thus indirectly transmitted to the inside of the heat ray-shielding material.

The metal oxide particle-containing layer is not particularly limited and can be appropriately selected according to the intended purpose as long as the metal oxide particle-containing layer is a layer containing at least one type of metal oxide particles.

The material of the metal oxide particles is not particularly limited and can be appropriately selected according to the intended purpose; examples of the material include tin-doped indium oxide (hereinafter, abbreviated as “ITO”), tin-doped antimony oxide (hereinafter, abbreviated as “ATO”), zinc oxide, titanium oxide, indium oxide, tin oxide, antimony oxide and glass ceramics. Among these, ITO, ATO and zinc oxide are more preferable because ITO, ATO and zinc oxide are excellent in heat ray absorption capability and capable of producing a heat ray-shielding material having a broad heat ray absorbing performance through combination with tabular silver particles, and ITO is particularly preferable because ITO shields 90% or more of infrared ray having a wavelength of 1,200 nm or more and has a visible light transmittance of 90% or more.

The volume average particle diameter of the primary particles of the metal oxide particles is preferably 0.1 μm or less for the purpose of not decreasing the visible light transmittance.

The shape of the metal oxide particles is not particularly limited and can be appropriately selected according to the intended purpose; examples of the shape of the metal oxide particles include a spherical shape, a needle-like shape and a tabular shape.

The content of the metal oxide particles in the metal oxide particle-containing layer is not particularly limited and can be appropriately selected according to the intended purpose, but is preferably 0.1 g/m² to 20 g/m², more preferably 0.5 g/m² to 10 g/m² and more preferably 1.0 g/m² to 4.0 g/m².

When the content is less than 0.1 g/m², the intensity of solar radiation felt on the skin is sometimes increased, and when the content exceeds 20 g/m², the visible light transmittance is sometimes degraded. On the other hand, the content falling within the range from 1.0 g/m² to 4.0 g/m² is advantageous in that the foregoing two disadvantages can be avoided.

The content of the metal oxide particles in the metal oxide particle-containing layer can be derived, for example, as follows: from the observation of the ultrathin section TEM image and the surface SEM image of the heat ray shielding layer, the number of the metal oxide particles and the average particle diameter in a predetermined area are measured; and the mass (g) derived on the basis of the number of the particles, the average particle diameter and the specific gravity of the metal oxide particles is divided by the predetermined area (m²) to derive the content. The content can also be derived as follows: the minute particles of the metal oxide in the predetermined area of the metal oxide metal oxide particle-containing layer is eluted into methanol; the mass (g) of the metal oxide minute particles is measured by the X-ray fluorescence measurement; and the resulting mass is divided by the predetermined area (m²) to derive the content.

### <<Hard Coat Layer>>

For imparting scratch resistance, it is also preferable for a functional film to include a hard coat layer having hard coat property.

The hard coat layer is not particularly limited, and the type thereof and the formation method thereof can be appropriately selected according to the intended purpose; examples of the type of the hard coat layer include thermosetting or photocurable resins such as acrylic resin, silicone-based resin, melamine-based resin, urethane-based resin, alkyd-based resin and fluorine-based resin. The thickness of the hard coat layer is not particularly limited and can be appropriately selected according to the intended purpose, but is preferably 1 μm to 50 μm. By further forming an antireflection layer and/or an antiglare layer on the hard coat layer, a functional film is preferably obtained which has antireflection property and/or antiglare property in addition to scratch resistance. The hard coat layer may also include the metal oxide particles.

### <<Protective Layer>>

The heat ray-shielding material of the present invention preferably includes a protective layer for the purpose of improving the adhesiveness to the substrate or protecting in relation to mechanical strength.

The protective layer is not particularly limited and can be appropriately selected according to the intended purpose; however, the protective layer includes, for example, a binder and a surfactant, and if necessary, other components. The binder is not particularly limited and can be appropriately selected according to the intended purpose, and can use the binders quoted as examples for the ultraviolet absorbing layer.

### <Method for Producing Heat Ray-Shielding Material>

The method for producing the heat ray-shielding material of the present invention is not particularly limited and can be appropriately selected according to the intended purpose; examples of such a method include a method in which on the surface of the substrate, the metal particle-containing layer, the ultraviolet absorbing layer, and further, if necessary, other layers are formed by application methods.

### —Method for Forming Metal Particle-Containing Layer—

The method for forming the metal particle-containing layer of the present invention is not particularly limited and can be appropriately selected according to the intended purpose; examples of such a method include: a method in which on the surface of a lower layer such as the substrate, a dispersion including the tabular metal particles is applied, for example, by a dip coater, a die coater, a slit coater, a bar coater or a gravure coater; and a method in which on the surface of a lower layer such as the substrate, a dispersion including the tabular metal particles is plane-oriented by a method such as a LB film method, a self-assembly method or a spray application method. When the heat ray-shielding material of the present invention is produced, the composition of the metal particle-containing layer used below-described Examples is such that by adding a latex, 80% by number of the substantially hexagonal to substantially circular tabular metal particles are made to be present preferably within a range of d/2 or more preferably within a range of d/3 from the surface of the metal particle-containing layer. The addition amount of the latex is not particularly limited, but it is preferable to add the latex in an amount of, for example, 1 part by mass to 10,000 parts by mass in relation to 100 parts by mass of the tabular silver particles.

The method for forming the metal particle-containing layer may include a method in which the plane orientation is performed by using electrostatic interaction for the purpose of increasing the adsorptivity and the plane orientation property, to the surface of the substrate, of the tabular metal particles. Examples of such a method include a method in which when the surface of the tabular metal particles is negatively charged (for example, a state of the tabular metal particles being dispersed in a negatively chargeable medium such as citric acid), the surface of the substrate is positively charged (for example, the surface of the substrate is modified with an amino group) to electrostatically increase the plane orientation property, and thus the tabular metal particles are plane-oriented. When the surface of the tabular metal particles is hydrophilic, the surface of the substrate is made to have a hydrophilic-hydrophobic sea-island structure formed thereon by use of a block copolymer or the micro contact stamp method, and the plane orientation property and the inter-particle distance of the tabular metal particles may be controlled by taking advantage of hydrophilic-hydrophobic interaction.

For the purpose of promoting the plane orientation, after the application of the tabular metal particles, the heat ray-shielding material may be made to pass through a pressure roller such as a calender roller or a laminating roller.

### —Method for Forming Ultraviolet Absorbing Layer—

The method for forming the ultraviolet absorbing layer is not particularly limited and a heretofore known method can be appropriately selected according to the intended purpose as long as the ultraviolet absorbing layer includes at least one type of the ultraviolet absorbers. When the ultraviolet absorbing layer is an adhesive layer, in the below-described method for forming the adhesive layer, the adhesive layer may be formed by including at least one type of the ultraviolet absorbers, or alternatively, a commercially available adhesive layer including the ultraviolet absorber(s) may also be used.

When the ultraviolet absorbing layer is the substrate, the substrate may be formed by including at least one type of the ultraviolet absorber in the materials for the substrate, or alternatively, a commercially available substrate including the ultraviolet absorber(s) may also be used. Examples of such commercially available products include ultraviolet light absorbing PET films such as TEIJIN (registered trademark) TETRON (registered trademark) film (manufactured by Teijin DuPont Films Ltd.).

When the ultraviolet absorbing layer is an intermediate layer, which is neither the adhesive layer nor the substrate, it is preferable to form the ultraviolet absorbing layer by application. The application method in this case is not particularly limited, and heretofore known methods can be used; examples of such a method include a method in which a dispersion including the ultraviolet absorber(s) is applied with a device such as a dip coater, a die coater, a slit coater, a bar coater or a gravure coater.

### —Methods for Forming Other Layers—

### —Method for Forming Adhesive Layer—

The adhesive layer is preferably formed by application. For example, the adhesive layer can be laminated on the surface of a lower layer such as the substrate, the metal particle-containing layer or the ultraviolet absorbing layer. The application method in this case is not particularly limited, and heretofore known methods can be used.

The solar reflectance of the heat ray-shielding material of the present invention preferably has a maximum value in the range from 600 nm to 2,000 nm (preferably from 800 nm to 1,800 nm), because the efficiency of the heat ray reflectance can be increased.

The visible light transmittance of the heat ray-shielding material of the present invention is preferably 60% or more and more preferably 70% or more. When the visible light transmittance is less than 60%, in the case where the heat ray-shielding material is used for a pane of glass for an automobile or for a pane of glass for a building, it sometimes becomes difficult to view the outside.

The ultraviolet light transmittance of the heat ray-shielding material of the present invention is preferably 5% or less and more preferably 2% or less. When the ultraviolet light transmittance exceeds 5%, the hue of the tabular metal particle layer is sometimes changed due to the ultraviolet light of sunlight.

The haze of the heat ray-shielding material of the present invention is preferably 20% or less. When the haze exceeds 20%, in the case where the heat ray-shielding material is used for a pane of glass for an automobile or for a pane of glass for a building, for example, it sometimes becomes difficult to view the outside so as to be undesirable from viewpoint of safety.

### —Lamination of Adhesive Layer by Dry Lamination—

When functionality is imparted to a fitted pane of window glass or the like by using the heat ray-shielding material film of the present invention, an adhesive is laminated on the room-side surface of the pane of glass window and then the film is attached to the room-side surface of the pane of glass window. In this case, the heat generation is prevented by disposing the reflection layer on the side of sunlight, and hence it is appropriate to laminate the adhesive layer on the nanodisc silver particle layer and to laminate the adhesive layer to the pane of window glass.

When the adhesive layer is laminated on the surface of the silver nanodisc layer, the surface can be directly coated with an application liquid containing the adhesive, but in this case, for example, the various additives, a plasticizer and the solvent used as contained in the adhesive sometimes disturbs the arrangement in the silver nanodisc layer, or sometimes modifies the silver nanodiscs themselves. For the purpose of minimizing such adverse effects, it is effective to laminate the adhesive layer and the silver nanodisc layer, being each in a dry state, on each other as follows: the adhesive is beforehand applied to a release film and dried to prepare a film, and the adhesive side of the film and the surface of the silver nanodisc layer of the film of the present invention are laminated on each other.

### (Laminated Structure)

The laminated structure of the present invention is formed by laminating the heat ray-shielding material of the present invention and either a sheet of glass or a sheet of a plastic to each other.

The method for producing the laminated structure is not particularly limited and can be appropriately selected according to the intended purpose; examples of such a method include a method in which the heat ray-shielding material of the present invention produced as described above is laminated to a sheet of glass or a plastic for a vehicle such as an automobile or a sheet of glass or a plastic for building materials.

[Aspects of Use of Heat ray-shielding material and Laminated Structure]

The heat ray-shielding material of the present invention is not particularly limited and can be appropriately selected according to the intended purpose as long as the heat ray-shielding material is involved in an aspect of being used for the purpose of selectively reflecting or absorbing heat ray (near-infrared ray); examples of such an aspect include film or laminated structure for a vehicle, film or laminated structure for building materials and agricultural film. Among these, from the viewpoint of the effect of energy saving, the aspect is preferably film or laminated structure for a vehicle and film or laminated structure for building materials.

In the present invention, heat ray (near-infrared ray) means the near-infrared ray (780 nm to 1,800 nm) accounting for about 50% of sunlight.

### EXAMPLES

Hereinafter, the present invention is described with reference to Examples and Comparative Examples of the present invention, but the present invention is not limited to these Examples at all. It is to be noted that Comparative Examples are not necessarily heretofore known techniques.

The items such as materials, used amounts, proportions, details of treatments and procedures shown in following Examples may be appropriately altered as long as not deviating from the gist of the present invention. Accordingly, the scope of the present invention should not be construed as restricted by the specific examples presented below.

### Production Example 1

### Preparation of Tabular Silver Particle Dispersion B1

### —Synthesis of Tabular Silver Particles—

### ——Step of Synthesizing Tabular Nucleus Particles——

To 50 mL of a 2.5 mmol/L aqueous solution of sodium citrate, 2.5 mL of a 0.5 g/L aqueous solution of polystyrenesulfonic acid was added and heated to 35° C. To the solution, 3 mL of a 10 mmol/L aqueous solution of sodium borohydride was added, and 50 mL of a 0.5 mmol/L aqueous solution of silver nitrate was added under stirring at a rate of 20 mL/min. The resulting solution was stirred for 30 minutes to prepare a seed solution.

### ——First Step of Growing Tabular Particles——

Next, to 250 mL of the seed solution, 2 mL of a 10 mmol/L aqueous solution of ascorbic acid was added and heated to 35° C. To the solution, 79.6 mL of a 0.5 mmol/L aqueous solution of silver nitrate was added under stirring at a rate of 10 mL/min.

### ——Second Step of Growing Tabular Particles——

Further, after the solution was stirred for 30 minutes, to the solution, 71.1 mL of a 0.35 mol/L aqueous solution of potassium hydroquinonesulfonate was added and 200 g of a 7% by mass aqueous solution of gelatin was added. To the resulting solution, a liquid mixture of the white precipitate of silver sulfite prepared by mixing 107 mL of a 0.25 mol/L aqueous solution of sodium sulfite and 107 mL of a 0.47 mol/L aqueous solution of silver nitrate was added. The solution was stirred until silver was sufficiently reduced, and 72 mL of a 0.17 mol/L aqueous solution of NaOH was added. Thus, a tabular silver particle dispersion A was obtained.

In the tabular silver particle dispersion A obtained, the production of hexagonal tabular silver particles (hereinafter, referred to as hexagonal tabular Ag particles) having an average equivalent circle diameter of 240 nm was verified. The thickness values of the hexagonal tabular particles were measured with an atomic force microscope (Nanocute II, manufactured by Seiko Instruments Inc.), and it was found that tabular particles having an average thickness of 8 nm and an aspect ratio of 17.5 were produced. The results thus obtained are shown in Table 1.

To 12 mL of the tabular silver particle dispersion A, 0.5 mL of 1N NaOH was added and 18 mL of ion-exchanged water was added; the resulting dispersion was centrifuged with a centrifugal separator (H-200N, amble Rotor BN, manufactured by Kokusan Co., Ltd.) and the hexagonal tabular Ag particles were precipitated. The supernatant liquid after the centrifugal separation was discarded, 2 mL of water was added to the residue, the precipitated hexagonal tabular Ag particles were redispersed to obtain the tabular silver particle dispersion B1 of Production Example 1.

### Production Example 2

### Preparation of Tabular Silver Particle Dispersion B2

The tabular silver particle dispersion B2 was prepared in the same manner as for the tabular silver particle dispersion B1 except that in the tabular silver particle dispersion B1 of Production Example 1, the addition amount of the seed solution was altered from 250 mL to 127.6 mL, 132.7 mL of a 2.5 mmol/L aqueous solution of sodium citrate was added and 72 mL of a 0.05 mol/L aqueous solution of NaOH was added immediately after the addition of the liquid mixture of the white precipitate of silver sulfite.

### Production Example 3

### Preparation of Tabular Silver Particle Dispersion B3

The tabular silver particle dispersion B3 was prepared in the same manner as for the tabular silver particle dispersion B1 except that in the tabular silver particle dispersion B1 of Production Example 1, the addition amount of the seed solution was altered from 250 mL to 80 mL, 132.7 mL of a 2.5 mmol/L aqueous solution of sodium citrate and 49.5 mL of ion-exchanged water were added.

### Production Example 4

### Preparation of Tabular Silver Particle Dispersion B4

The tabular silver particle dispersion B4 was prepared in the same manner as for the tabular silver particle dispersion B3 except that in the tabular silver particle dispersion B3 of Production Example 3, the addition amount of the seed solution was altered from 250 mL to 39 mL.

### Production Example 5

### Preparation of Tabular Silver Particle Dispersion B5

The tabular silver particle dispersion B5 was prepared in the same manner as for the tabular silver particle dispersion B2 except that in the tabular silver particle dispersion B2 of Production Example 2, instead of the addition of 72 mL of the 0.05 mol/L aqueous solution of NaOH immediately after the addition of the liquid mixture of the white precipitate of silver sulfite, 72 mL of a 1 mol/L of aqueous solution of NaOH was added.

### Production Example 6

### Preparation of Tabular Silver Particle Dispersion B6

The tabular silver particle dispersion B6 was prepared in the same manner as for the tabular silver particle dispersion B1 except that in the tabular silver particle dispersion B1 of Production Example 1, the 0.25 mol/L aqueous solution of sodium sulfite was replaced with a 0.5 mol/L aqueous solution of sodium sulfite.

### Production Example 7

### Preparation of Tabular Silver Particle Dispersion B7

The tabular silver particle dispersion B7 was prepared in the same manner as for the tabular silver particle dispersion B1 except that in the tabular silver particle dispersion B1 of Production Example 1, the 0.25 M aqueous solution of sodium sulfite was replaced with a 0.75 mol/L aqueous solution of sodium sulfite.

### <<Evaluation of Metal Particles>>

—Proportion, Average particle diameter (Average Equivalent Circle Diameter) and Coefficient of Variation of Tabular Particles—

With respect to the shape uniformity of the tabular Ag particles, the shapes of 200 particles randomly sampled from the observed SEM image were subjected to image analysis under the conditions that the substantially hexagonal to substantially circular tabular particles were classified as A and the particles having an irregular shape such as a teardrop shape were classified as B, and the proportion (%) of the particles corresponding to A was determined. Similarly, the particle sizes of 100 of the particles corresponding to A were measured with a digital caliper, and the average value of the measured particle sizes was taken as the average particle diameter (average equivalent circle diameter), and the coefficient of variation (%) was determined by dividing the standard deviation of the particle size distribution by the average particle diameter (average equivalent circle diameter).

### —Average Particle Thickness—

The obtained dispersion containing tabular metal particles was dropwise placed on a glass substrate and dried, and the thickness of each of the single tabular metal particles was measured with an atomic force microscope (AFM) (NanocuteII, manufactured by Seiko Instruments Inc.). The measurement conditions using an AFM were such that a self-detection-type sensor was used, a DFM mode was adopted, the measurement range was 5 μm, the scan rate was 180 sec/1 frame, and the number of data points was 256×256.

### —Aspect Ratio—

On the basis of the average particle diameter (average equivalent circle diameter) obtained and the average particle thickness obtained of the tabular metal particles, the aspect ratio was derived by dividing the average particle diameter (average equivalent circle diameter) by the average particle thickness.

### —Transmission Spectra of Tabular Silver Particle Dispersions—

The transmission spectra of the tabular silver particle dispersions obtained were evaluated by diluting with water the tabular silver particle dispersions and by using a UV-visible-near-infrared spectrophotometer (V-670, manufactured by JASCO Corp.).

TABLE 1

| | | Metal particle shape | | Proportion | | | | | |
|---|---|---|---|---|---|---|---|---|---|
| | | | Irregular | (% by number) | Properties of substantially | | | | |
| | | | and/or | of the | hexagonal to substantially | | | | |
| | Proportion of | | polygonal | substantially | circular tabular particles A | | | | |
| | tabular | Substantially | tabular | hexagonal to | Average | Coefficient of | | | Peak |
| | particles A | hexagonal to | particles B | substantially | particle | variation of | Average | | wavelength of |
| | relative to | substantially | substantially | circular tabular | diameter | particle size | thickness | Aspect | transmission |
| | total metal | circular | lower in | particles A | of tabular | distribution of | of tabular | ratio | spectrum of |
| | particles | tabular | symmetry | relative to total | particles | tabular particles | particles | of tabular | metal particle |
| | (% by number) | particles A | than hexagon | metal particles | (nm) | (%) | (nm) | particles | dispersion (nm) |
| Tabular silver | 93 | Substantially | Irregular | 93 | 140 | 7 | 8 | 17.5 | 1,010 |
| particle | | hexagonal | tablets | | | | | | |
| dispersion B1 | | | | | | | | | |
| Tabular silver | 92 | Substantially | Irregular | 92 | 180 | 9 | 9 | 20 | 1,150 |
| particle | | hexagonal | tablets | | | | | | |
| dispersion B2 | | | | | | | | | |
| Tabular silver | 93 | Substantially | Irregular | 93 | 240 | 7 | 8 | 29.8 | 1,440 |
| particle | | hexagonal | tablets | | | | | | |
| dispersion B3 | | | | | | | | | |
| Tabular silver | 93 | Substantially | Irregular | 93 | 330 | 8 | 8 | 41.3 | 1,810 |
| particle | | hexagonal | tablets | | | | | | |
| dispersion B4 | | | | | | | | | |
| Tabular silver | 90 | Substantially | Irregular | 90 | 125 | 11 | 16 | 7.8 | 710 |
| particle | | hexagonal | tablets | | | | | | |
| dispersion B5 | | | | | | | | | |
| Tabular silver | 68 | Substantially | Irregular and | 68 | 155 | 26 | 8 | 19.4 | 1,120 |
| particle | | hexagonal | substantially | | | | | | |
| dispersion B6 | | | triangle | | | | | | |
| | | | tablets | | | | | | |
| Tabular silver | 55 | substantially | Irregular and | 55 | 200 | 33 | 9 | 22.2 | 1,210 |
| particle | | hexagonal | Substantially | | | | | | |
| dispersion B7 | | | triangle | | | | | | |
| | | | tablets | | | | | | |

### [Preparation of Application Liquid 1 for Metal Particle-Containing Layer Including Tabular Metal Particles]

The application liquid 1 for the metal particle-containing layer, having the following composition was prepared.

### —Composition of Application Liquid 1 for Metal Particle-Containing Layer—

Polyester latex aqueous dispersion (Finetex ES-650, manufactured by DIC Corp., solid content concentration: 30% by mass) . . . 28.2 parts by mass
Surfactant A (Rapisol A-90, manufactured by NOF Corp., solid content: 1% by mass) . . . 12.5 parts by mass
Surfactant B (Naroacty CL-95, manufactured by Sanyo Chemical Industries, Ltd., solid content: 1% by mass) . . . 15.5 parts by mass
Tabular silver particle dispersion B1 . . . 200 parts by mass
Water . . . 800 parts by mass

### [Preparation of Application Liquid 2 for Ultraviolet Absorbing Layer]

The following composition was mixed, the volume average particle diameter was regulated by using a ball mill to be 0.6 μm and thus the application liquid 2 for the ultraviolet absorbing layer was prepared.

### —Composition of Application Liquid 2 for Ultraviolet Absorbing Layer—

Ultraviolet absorber (Tinuvin 326, manufactured by BASF Japan Ltd.) . . . 10 parts by mass
Binder (10% by mass polyvinyl alcohol solution) . . . 10 parts by mass
Water . . . 30 parts by mass

### [Preparation of Application Liquid 3 for Metal Oxide Particle-Containing Layer]

The application liquid 3 for the metal oxide particle-containing layer, having the following composition was prepared.

### —Composition of Application Liquid 3 for Metal Oxide Particle-Containing Layer—

Modified polyvinyl alcohol (PVA₂O₃, manufactured by Kuraray Co., Ltd.) . . . 10 parts by mass
Water . . . 371 parts by mass
Methanol . . . 119 parts by mass
ITO particles (manufactured by Mitsubishi Material Corp.) . . . 35 parts by mass

### [Preparation of Application Liquid 4 For Overcoat Layer]

The application liquid 4 for the overcoat layer was prepared so as for the solid content to have the following composition, and then to the application liquid 4, pure water was added so as for the application liquid 4 to have a solid content concentration of 1.4% by mass.

### —Composition of Application Liquid 4 for Overcoat Layer—

Olester UD350 (manufactured by Mitsui Chemicals, Inc.) . . . 6,390 parts by mass
EM-48 (manufactured by Daicel FineChem. Ltd.) . . . 519 parts by mass
Rapisol A-90 (manufactured by NOF Corp.) . . . 93 parts by mass
Naroacty HN-100 (manufactured by Sanyo Chemical Indusitries, Ltd.) . . . 114 parts by mass
Carbodilite V-02-L2 (manufactured by Nisshinbo Industries, Inc.) . . . 1,390 parts by mass
Aerosil OX-50 (manufactured by Japan Aerosil Co., Ltd.) . . . 114 parts by mass
Snowtex XL (manufactured by Nissan Chemical Industries, Ltd.) . . . 1,040 parts by mass
Cellosol 524F (manufactured by Chukyo Yushi Co., Ltd.) . . . 343 parts by mass

### [Preparation of Application Liquid 5 For Overcoat Layer]

The application liquid 5 for the overcoat layer was prepared so as for the solid content to have the following composition, and then to the application liquid 5, pure water was added so as for the application liquid 5 to have a solid content concentration of 1.4% by mass.

### —Composition of Application Liquid 5 for Overcoat Layer—

MX502α (manufactured by Soken Chemical & Engineering Co., Ltd.) . . . 89 parts by mass
NIKKOL SCS (manufactured by Nikko Chemicals Co., Ltd.) . . . 170 parts by mass
Denacol EX-521 (manufactured by Nagase ChenteX Corp.) . . . 373 parts by mass
Rapisol A-90 (manufactured by NOF Corp.) . . . 617 parts by mass
Pesresin A615GW (manufactured by Takamatsu Oil & Fat Co., Ltd.) . . . 3,470 parts by mass
Jurimer ET410 (manufactured by Toagosei Co., Ltd.) . . . 5,280 parts by mass

### [Preparation of Application Liquid 6 for Overcoat Layer]

The application liquid 6 for the overcoat layer was prepared so as for the solid content to have the following composition, and then to the application liquid 5, pure water was added so as for the application liquid 6 to have a solid content concentration of 1.4% by mass.

### —Composition of Application Liquid 6 for Overcoat Layer—

MX502α (manufactured by Soken Chemical & Engineering Co., Ltd.) . . . 89 parts by mass
NIKKOL SCS (manufactured by Nikko Chemicals Co., Ltd.) . . . 170 parts by mass
Denacol EX-521 (manufactured by Nagase ChenteX Corp.) . . . 373 parts by mass
RapisolA-90 (manufactured by NOF Corp.) . . . 617 parts by mass
Pesresin A615GW (manufactured by Takamatsu Oil & Fat Co., Ltd.) . . . 3,470 parts by mass
Jurimer ET410 (manufactured by Toagosei Co., Ltd.) . . . 5,280 parts by mass
Ultraviolet absorber (Tinuvin 326, manufactured by BASF Japan Ltd.) . . . 3,000 parts by mass

### [Preparation of Application Liquid 7 for Overcoat Layer]

The application liquid 7 for the overcoat layer having the following composition was prepared.

### —Composition of Application Liquid 7 for Overcoat Layer—

Diacetyl cellulose (manufactured by Daicel Chemical Industries, Ltd.) . . . 169 parts by mass
PMMA (manufactured by Fujikura Kasei Co., Ltd.) . . . 21.1 parts by mass
Colloidal silica (Aerosil, manufactured by Dainichiseika Color & Chemicals Mfg. Co., Ltd., average particle diameter: 0.02 μm). 65.6 parts by mass
Trimethylolpropane-3-toluene diisocyanate adduct (manufactured by Nippon Polyurethane Industry Co., Ltd.) . . . 105 parts by mass
Cyclohexanone . . . 519 parts by mass
Acetone . . . 9,120 parts by mass

### [Preparation of Application 8 for Overcoat Layer]

The application liquid 8 for the overcoat layer having the following composition was prepared.

### —Composition of Application Liquid 8 for Overcoat Layer—

Polyester resin (Byron UR-8200, manufactured by Toyobo Co., Ltd.) . . . 20 parts by mass
Polyester resin (Byron UR-8300, manufactured by Toyobo Co., Ltd.) . . . 80 parts by mass
Methyl ethyl ketone . . . 50 parts by mass

### Example 1

To the surface of a PET film (Fujipet, manufactured by Fujifilm Corp., thickness: 188 μm) used as a substrate, the application liquid 1 for the metal particle-containing layer was applied with a wire bar so as for the average thickness after drying to be 0.08 μm. Then, heating was performed at 150° C. for 10 minutes to dry and solidify the application liquid 1 applied and thus a metal particle-containing layer was formed.

Next, to the metal particle-containing layer, the application liquid 2 for the ultraviolet absorbing layer was applied with a wire bar so as for the average thickness after drying to be 0.5 μm. Then, heating was performed at 100° C. for 2 minutes to dry and solidify the application liquid 2 applied, and thus an ultraviolet absorbing layer doubling as an overcoat layer was formed.

Next, to the back side of the formed ultraviolet absorbing layer doubling as the overcoat layer of the substrate, namely, the surface of the PET film without the application liquid 1 applied thereto, the application liquid 3 was applied with a wire bar so as for the average thickness after drying to be 1.5 μM.

Next, to the surface with the application liquid 3 applied thereto, the UV-curable resin A (Z7410B, manufactured by JSR Corp., refractive index: 1.65) was applied so as for the layer thickness to be about 9 μm to provide an application layer, and then the application layer was dried at 70° C. for 1 minute. Next, the dried application layer was irradiated with ultraviolet light by using a high-pressure mercury lamp to cure the resin, and thus, a hard coat layer having a thickness of 3 μm was formed. The irradiation quantity of the ultraviolet light to the application layer was set at 1,000 mJ/cm². The layered product obtained in which lamination was performed in the order of hard coat layer/metal oxide particle-containing layer/substrate/metal particle-containing layer including tabular metal particles/ultraviolet absorbing layer doubling as coat layer was the heat ray shielding film.

The average thickness can be derived by measuring at 10 points as the thickness the difference between the thickness before the application and the thickness after the application with a laser microscope (VK-8510, manufactured by Keyence Corp.), and by averaging the thickness values thus obtained at the 10 points.

### (Lamination of Adhesive Layer)

After the surface of the heat ray shielding film obtained was cleaned, an adhesive layer was laminate on the cleaned surface. As the adhesive layer (adhesive), PET-W manufactured by Sanritz Corp. was used, one release sheet of PET-W was peeled off, and the resulting exposed surface was laminated on the surface of the ultraviolet absorbing layer of the heat ray shielding film.

In this way, the heat ray-shielding material of Example 1 was prepared in which lamination was performed in the order of hard coat layer/metal oxide particle-containing layer/substrate/metal particle-containing layer including tabular metal particles/ultraviolet absorbing layer doubling as overcoat layer/adhesive layer.

### (Preparation of Laminated Structure)

From the adhesive layer of the heat ray-shielding material obtained of Example 1, the other release sheet was peeled off, and the heat ray-shielding material was laminated on a sheet of transparent glass (thickness: 3 mm) to prepare the laminated structure of Example 1.

The sheet of transparent glass which was wiped to remove dirt with isopropyl alcohol and allowed to stand was used, and when the sheet of transparent glass was laminated, the sheet of transparent glass was pressure bonded by using a rubber roller under the conditions of a temperature of 25° C. and a humidity of 65% RH, with a contact pressure of 0.5 kg/cm².

### <<Evaluation of Heat Ray-Shielding Material>>

Next, the properties of the heat ray-shielding material obtained were evaluated as follows. The results thus obtained are shown in Table 2.

### —Inclination Angles of Particles—

After the heat ray-shielding material was subjected to embedding treatment with an epoxy resin, the embedded heat ray-shielding material was cleaved with a razor blade in a state of being frozen with liquid nitrogen to prepare the vertical direction cross-section sample of the heat ray-shielding material was. The vertical direction cross-section sample was observed with a scanning electron microscope (SEM), and for 100 of the substantially hexagonal to substantially circular tabular metal particles of the tabular metal particles, the inclination angles (corresponding to ±θ in FIG. 6B) in relation to the surface of the metal particle-containing layer (parallel to the horizontal plane of the substrate in present Example) were derived as an average value.

### [Evaluation Standards]

A: The inclination angle is ±30° or less.

B: The inclination angle exceeds ±30°.

### —Uneven Surface Distribution of Tabular Metal Particles on Surface of Metal Particle-Containing Layer—

With the foregoing cross-section SEM, the thickness of the metal particle-containing layer and the distances from the surface of the metal particle-containing layer of 100 of the tabular metal particles were measured.

### [Evaluation Standards]

A: Within the range of d/3 from the surface of the metal particle-containing layer, 80% by number or more of the tabular metal particles are present.

B: Within the range of d/3 from the surface of the metal particle-containing layer, 80% by number or less of the tabular metal particles are present.

### —Measurement of Reflection Spectra and Transmission Spectra—

The reflection spectrum and the transmission spectrum of each of the prepared heat ray-shielding material were measured with an UV-visible-near-infrared spectrophotometer (V-670, manufactured by JASCO Corp.). For the measurement of the reflection spectra, an absolute reflectance measurement unit (ARV-474, manufactured by JASCO Corp.) was used, and the incident light was made to pass through a 45° polarizer so as to be regarded as unpolarized incident light.

### —Visible Light Transmittance—

For each of the prepared heat ray-shielding materials, the transmittance at each of the measurement wavelengths ranging from 380 nm to 780 nm was corrected with the spectral luminous efficiency at the corresponding wavelength to derive the visible light transmittance at the corresponding wavelength.

### —Ultraviolet Light Transmittance—

For each of the prepared heat ray-shielding materials, from the transmittance at each of the measurement wavelengths ranging from 280 nm to 380 nm, the ultraviolet light transmittance was derived on the basis of the method described in JIS 5759, and thus evaluated.

### —Evaluation of Heat Shielding Capability—

For each of the prepared heat ray-shielding materials, from the transmittance at each of the measurement wavelengths ranging from 350 nm to 2,100 nm, the solar reflectance was derived on the basis of the method described in JIS 5759, and thus evaluated. As the evaluation of the heat shielding capability, it is preferable that the reflectance be high.

### [Evaluation Standards]

A: The reflectance is 20% or more.

B: The reflectance is 17% or more and less than 20%.

C: The reflectance is 13% or more and less than 17%.

D: The reflectance is less than 13%.

### —Degree of Yellowness—

A 200-hour weather resistance test was performed with a carbon arc sunshine weather meter (irradiance: 255 W/m², humidity: 50% RH, temperature: 63° C.), and from the spectral change between before and after the test, the degree of yellowness was derived on the basis of the method described in JIS K7105. As the evaluation of the degree of yellowness, the smaller the degree of yellowness, the more preferable.

### [Evaluation Standards]

A: The degree of yellowness is less than 0.5.

B: The degree of yellowness is 0.5 or more and less than 1.

C: The degree of yellowness is 1 or more and less than 2.

D: The degree of yellowness is 2 or more.

### Example 2

The heat ray-shielding material of Example 2 in which lamination was performed in the order of hard coat layer/metal oxide particle-containing layer/substrate/metal particle-containing layer including tabular metal particles/ultraviolet absorbing layer doubling as overcoat layer/adhesive layer and the laminated structure thereof were prepared in the same manner as in Example 1 except that in Example 1, the addition amount of Tinuvin 326 in the application liquid 2 was altered from 10 parts by mass to 1 part by mass.

### Example 3

The heat ray-shielding material of Example 3 in which lamination was performed in the order of hard coat layer/metal oxide particle-containing layer/substrate/metal particle-containing layer including tabular metal particles/ultraviolet absorbing layer doubling as overcoat layer/adhesive layer and the laminated structure thereof were prepared in the same manner as in Example 1 except that in Example 1, the addition amount of Tinuvin 326 in the application liquid 2 was altered from 10 parts by mass to 0.5 part by mass.

### Example 4

The heat ray-shielding material of Example 4 in which lamination was performed in the order of hard coat layer/metal oxide particle-containing layer/substrate/metal particle-containing layer including tabular metal particles/ultraviolet absorbing layer doubling as overcoat layer/adhesive layer and the laminated structure thereof were prepared in the same manner as in Example 1 except that in Example 1, the tabular silver particle dispersion B1 of the application liquid 1 was replaced with the tabular silver particle dispersion B2.

### Example 5

The heat ray-shielding material of Example 5 in which lamination was performed in the order of hard coat layer/substrate/metal particle-containing layer including tabular metal particles/ultraviolet absorbing layer doubling as overcoat layer/adhesive layer and the laminated structure thereof were prepared in the same manner as in Example 1 except that in Example 1, the addition amount of the tabular silver particle dispersion B1 of the application liquid 1 was altered from 200 parts by mass to 100 parts by mass, the tabular silver particle dispersion B3 was further added in an amount of 100 parts by mass, and the hard coat layer was formed, without applying the application liquid 3, on the surface of the substrate opposite to the surface of the substrate on which the metal particle-containing layer including tabular metal particles was formed.

### Example 6

The heat ray-shielding material of Example 6 in which lamination was performed in the order of hard coat layer/metal oxide particle-containing layer/substrate/metal particle-containing layer including tabular metal particles/ultraviolet absorbing layer doubling as overcoat layer/adhesive layer and the laminated structure thereof were prepared in the same manner as in Example 1 except that in Example 1, the tabular silver particle dispersion B1 of the application liquid 1 was replace with the tabular silver particle dispersion B4.

### Example 7

The heat ray-shielding material of Example 7 in which lamination was performed in the order of hard coat layer/metal oxide particle-containing layer/substrate/metal particle-containing layer including tabular metal particles/ultraviolet absorbing layer doubling as overcoat layer/adhesive layer and the laminated structure thereof were prepared in the same manner as in Example 1 except that in Example 1, the tabular silver particle dispersion B1 of the application liquid 1 was replaced with the tabular silver particle dispersion B5.

### Example 8

The heat ray-shielding material of Example 8 in which lamination was performed in the order of adhesive layer/substrate (doubling as ultraviolet absorbing layer)/metal particle-containing layer including tabular metal particles/metal oxide particle-containing layer doubling as overcoat layer/hard coat layer and the laminated structure thereof were prepared in the same manner as in Example 1 except that in Example 1, the PET film was replaced with an ultraviolet light absorbing PET film (TEIJIN (registered trademark) TETRON (registered trademark) film, manufactured by Teijin DuPont Films Ltd.), the application liquid 2 was not applied, the application liquid 3 was applied on the metal particle-containing layer and the hard coat layer was disposed on the layer of the application liquid 3, and the PET-W, an adhesive layer, was laminated on the surface, on which the application liquid 1 was not applied, of the ultraviolet light absorbing PET film.

### Example 9

The heat ray-shielding material of Example 9 in which lamination was performed in the order of hard coat layer/metal oxide particle-containing layer/substrate/metal particle-containing layer including tabular metal particles/ultraviolet absorbing layer doubling as overcoat layer/adhesive layer (doubling as ultraviolet absorbing layer) was prepared in the same manner as in Example 1 except that in Example 1, as the adhesive layer, in place of PET-W, an ultraviolet absorber-containing PVB film was laminated with a laminator.

The laminated structure of Example 9 was prepared as follows: the surface of the adhesive layer of the heat ray-shielding material obtained was laminated to a sheet of transparent glass (thickness: 3 mm), preliminarily pressure bonded under a vacuum condition at 90° C. over 10 minutes, and then, finally pressure bonded in an autoclave at 130° C. and 30 MPa over 30 minutes to prepare the laminated structure.

### Example 10

The heat ray-shielding material of Example 10 in which lamination was performed in the order of hard coat layer/metal oxide particle-containing layer/substrate/metal particle-containing layer including tabular metal particles/ultraviolet absorbing layer doubling as overcoat layer/adhesive layer and the laminated structure thereof were prepared in the same manner as in Example 1 except that in Example 1, the tabular silver particle dispersion B1 of the application liquid 1 was replaced with the tabular silver particle dispersion B6.

### Example 11

The heat ray-shielding material of Example 11 in which lamination was performed in the order of hard coat layer/metal oxide particle-containing layer/substrate/metal particle-containing layer including tabular metal particles/overcoat layer/ultraviolet absorbing layer/adhesive layer and the laminated structure thereof were prepared in the same manner as in Example 1 except that in Example 1, an overcoat layer 4 was disposed between the metal particle-containing layer and the ultraviolet absorbing layer.

When the overcoat layer 4 was disposed, the application liquid 4 was applied to the formed metal particle-containing layer with a wire bar so as for the average thickness after drying to be 1.0 μm. Then, heating was performed at 120° C. for 30 seconds to dry and solidify the application liquid 4 applied and thus the overcoat layer 4 was formed.

### Example 12

The heat ray-shielding material of Example 12 in which lamination was performed in the order of hard coat layer/metal oxide particle-containing layer/substrate/metal particle-containing layer including tabular metal particles/overcoat layer/ultraviolet absorbing layer/adhesive layer and the laminated structure thereof were prepared in the same manner as in Example 1 except that in Example 1, an overcoat layer 5 was disposed between the metal particle-containing layer and the ultraviolet absorbing layer.

When the overcoat layer 5 was disposed, the application liquid 5 was applied to the formed metal particle-containing layer with a wire bar so as for the average thickness after drying to be 1.0μm. Then, heating was performed at 120° C. for 30 seconds to dry and solidify the application liquid 5 applied and thus the overcoat layer 5 was formed.

### Example 13

The heat ray-shielding material of Example 13 in which lamination was performed in the order of hard coat layer/metal oxide particle-containing layer/substrate/metal particle-containing layer including tabular metal particles/overcoat layer/ultraviolet absorbing layer/adhesive layer and the laminated structure thereof were prepared in the same manner as in Example 1 except that in Example 1, an overcoat layer 6 was disposed between the metal particle-containing layer and the ultraviolet absorbing layer.

When the overcoat layer 6 was disposed, the application liquid 6 was applied to the formed metal particle-containing layer with a wire bar so as for the average thickness after drying to be 1.0 Then, heating was performed at 120° C. for 30 seconds to dry and solidify the application liquid 6 applied and thus the overcoat layer 6 was formed.

### Example 14

The heat ray-shielding material of Example 14 in which lamination was performed in the order of hard coat layer/metal oxide particle-containing layer/substrate/metal particle-containing layer including tabular metal particles/overcoat layer/ultraviolet absorbing layer/adhesive layer and the laminated structure thereof were prepared in the same manner as in Example 1 except that in Example 1, an overcoat layer 7 was disposed between the metal particle-containing layer and the ultraviolet absorbing layer.

When the overcoat layer 7 was disposed, the application liquid 7 was applied to the formed metal particle-containing layer with a wire bar so as for the average thickness after drying to be 1.0 μm. Then, heating was performed at 120° C. for 30 seconds to dry and solidify the application liquid 7 applied and thus the overcoat layer 7 was formed.

### Example 15

The heat ray-shielding material of Example 15 in which lamination was performed in the order of hard coat layer/metal oxide particle-containing layer/substrate/metal particle-containing layer including tabular metal particles/adhesive layer doubling as overcoat layer and the laminated structure thereof were prepared in the same manner as in Example 1 except that in Example 1, the application liquid 2 was not applied.

### Example 16

The heat ray-shielding material of Example 16 in which lamination was performed in the order of hard coat layer/metal oxide particle-containing layer/substrate/metal particle-containing layer including tabular metal particles/ultraviolet absorbing layer doubling as overcoat layer/adhesive layer and the laminated structure thereof were prepared in the same manner as in Example 1 except that in Example 1, in the preparation of the application liquid 1 for the metal particle-containing layer, the polyester latex aqueous dispersion, the surfactant A and the surfactant B were not added, but instead the surfactant C (the compound represented by the following structural formula W-1, solid content: 2% by mass) was added in an amount of 200 parts by mass.

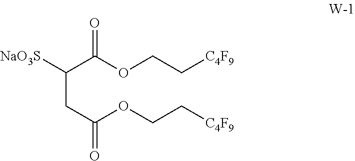

### Example 17

The application liquid 1 for the metal particle-containing layer was applied with a wire bar to the surface of the PET film (Fujipet, manufactured by Fujifilm Corp., thickness: 188 μm) used as the substrate so as for the average thickness after drying to be 0.08 μm. Then, heating was performed at 150° C. for 10 minutes to dry and solidify the application liquid 1 applied and thus the metal particle-containing layer was formed.

Next, the application liquid 8 for the overcoat layer was applied with a wire bar #6 to the formed metal particle-containing layer, and then heating was performed at 80° C. for 1 minute to dry and solidify the application liquid 8 applied, and thus the overcoat layer 8 was formed.

The layered product obtained in which lamination was performed in the order of substrate/metal particle-containing layer including tabular metal particles/overcoat layer was adopted as a heat ray shielding film.

### —Lamination of Adhesive Layer—

The surface of the heat ray shielding film obtained was cleaned, and then an adhesive layer was laminated on the cleaned surface. As the adhesive layer (adhesive), a PVB film including an ultraviolet absorber was laminated with a laminator.

As described above, the heat ray-shielding material of Example 17 in which lamination was performed in the order of substrate/metal particle-containing layer including tabular metal particles/overcoat layer/adhesive layer (including an ultraviolet absorber) was prepared.

### —Preparation of Laminated Structure—

From the adhesive layer of the heat ray-shielding material obtained of Example 17, the other release sheet was peeled off, and the heat ray-shielding material was laminated on a sheet of transparent glass (thickness: 3 mm) to prepare the laminated structure of Example 17.

The sheet of transparent glass which was wiped to remove dirt with isopropyl alcohol and allowed to stand was used, and when the sheet of transparent glass was laminated, the sheet of transparent glass was pressure bonded by using a rubber roller under the conditions of a temperature of 25° C. and a humidity of 65% RH, with a contact pressure of 0.5 kg/cm².

### Comparative Example 1

The heat ray-shielding material of Comparative Example 1 in which lamination was performed in the order of adhesive layer/hard coat layer/metal oxide particle-containing layer/substrate/metal particle-containing layer including tabular metal particles and the laminated structure thereof were prepared in the same manner as in Example 16 except that in Example 16, the application liquid 2 for the ultraviolet absorbing layer was not applied, and an adhesive material was laminated on the hard coat layer.

### Comparative Example 2

The heat ray-shielding material of Comparative Example 2 in which lamination was performed in the order of hard coat layer/metal oxide particle-containing layer/substrate/metal particle-containing layer including tabular metal particles/ultraviolet absorbing layer doubling as overcoat layer/adhesive layer and the laminated structure thereof were prepared in the same manner as in Example 1 except that in Example 1, 100 parts by mass of gelatin was further added to the application liquid 1 for the metal particle-containing layer. The addition of gelatin disturbed the arrangement of the metal particles to degrade the plane orientation property (see Table 2 presented below).

### Comparative Example 3

The heat ray-shielding material of Comparative Example 3 in which lamination was performed in the order of hard coat layer/metal oxide particle-containing layer/substrate/metal particle-containing layer including tabular metal particles/ultraviolet absorbing layer doubling as overcoat layer/adhesive layer and the laminated structure thereof were prepared in the same manner as in Example 1 except that in Example 1, the tabular silver particle dispersion B1 of the application liquid 1 for the metal particle-containing layer was replaced with the tabular silver particle dispersion B7.

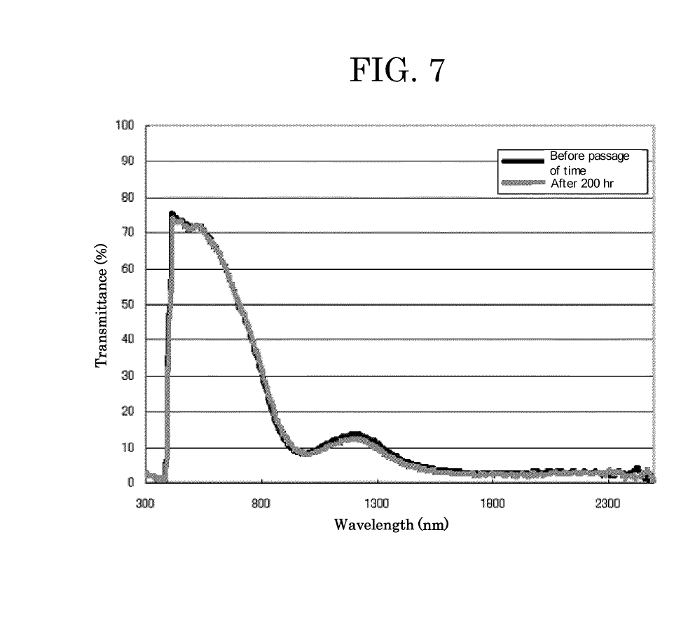

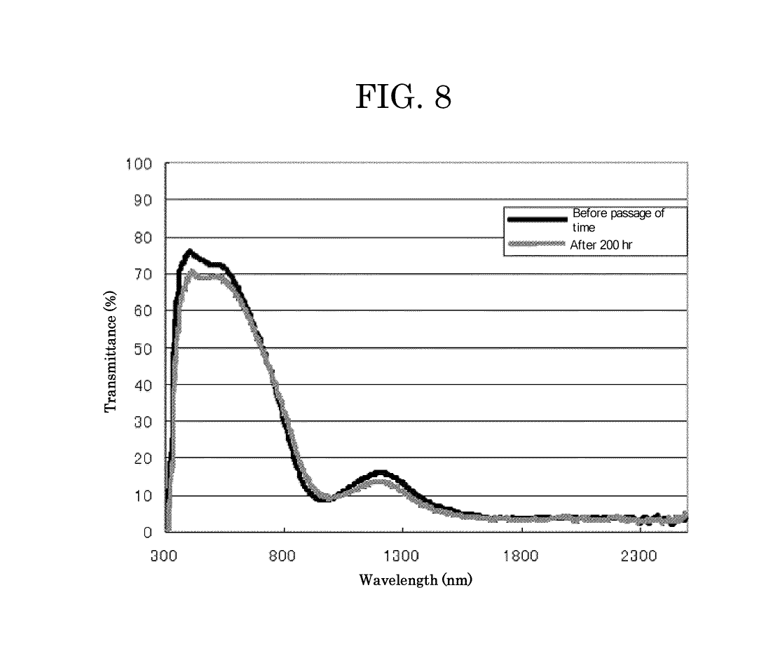

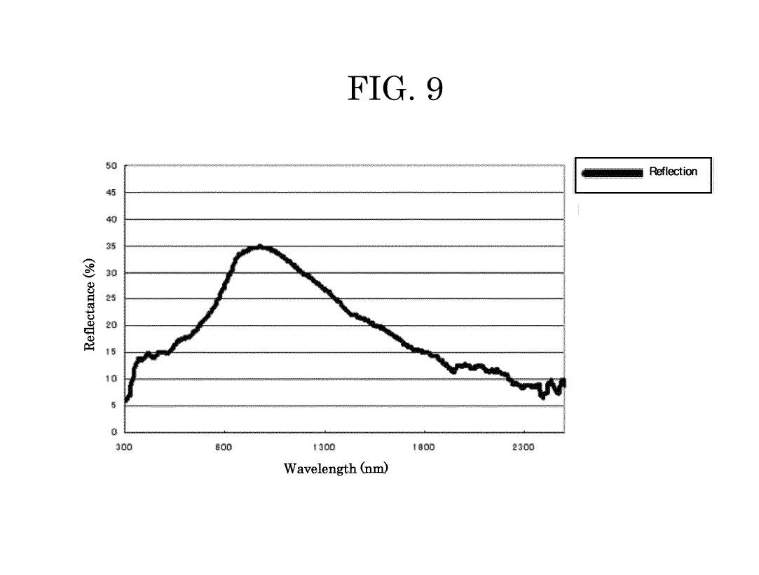

The properties of the heat ray-shielding materials of the Examples 2 to 17 and Comparative Examples 1 to 3 were evaluated in the same manner as for Example 1. The results thus obtained are shown in Table 2. FIG. 7 shows the transmission spectra before and after a weather resistance test for the heat ray-shielding material of Example 1, FIG. 8 shows the transmission spectra before and after a weather resistance test for the heat ray-shielding material of Example 15, and FIG. 9 shows the reflection spectrum of the heat ray-shielding material of Example 1.

TABLE 2

| | | | Uneven | | | | | | |
|---|---|---|---|---|---|---|---|---|---|
| | | Particle | distri- | | | | | | |
| | | inclination | bution | Overcoat layer of | | | | | |
| | | angle | of metal | surface with uneven | | | | | |
| | | (Plane | tabular | distribution of | | Visible light | UV light | Heat | |
| | | orientation | particles | tabular metal | Location of | transmittance | transmittance | shielding | Degree of |
| | Tabular metal particle | property) | on surface | particles | UV absorber | (%) | (%) | capability | Yellowness |
| Ex. 1 | Tabular silver particle | A | A | UV absorbing layer | UV absorbing | 70.1 | 0.3 | A | A |
| | dispersion B1 | | | | layer | | | | |
| Ex. 2 | Tabular silver particle | A | A | UV absorbing layer | UV absorbing | 70.4 | 3.1 | A | B |
| | dispersion B1 | | | | layer | | | | |
| Ex. 3 | Tabular silver particle | A | A | UV absorbing layer | UV absorbing | 70.2 | 7.2 | A | C |
| | dispersion B1 | | | | layer | | | | |
| Ex. 4 | Tabular silver particle | A | A | UV absorbing layer | UV absorbing | 71.3 | 0.3 | B | A |
| | dispersion B2 | | | | layer | | | | |
| Ex. 5 | Tabular silver particle | A | A | UV absorbing layer | UV absorbing | 70.5 | 0.3 | A | A |
| | dispersions | | | | layer | | | | |
| | B1 and B3 | | | | | | | | |
| Ex. 6 | Tabular silver particle | A | A | UV absorbing layer | UV absorbing | 78.5 | 0.3 | C | A |
| | dispersion B4 | | | | layer | | | | |
| Ex. 7 | Tabular silver particle | A | A | UV absorbing layer | UV absorbing | 61.2 | 0.3 | B | A |
| | dispersion B5 | | | | layer | | | | |
| Ex. 8 | Tabular silver particle | A | A | Metal oxide | Substrate | 70.0 | 0.3 | A | A |
| | dispersion B1 | | | particle-containing | | | | | |
| | | | | layer | | | | | |
| Ex. 9 | Tabular silver particle | A | A | UV absorbing layer | UV absorbing | 70.1 | 0.1 | A | A |
| | dispersion B1 | | | | layer and | | | | |
| | | | | | adhesive layer | | | | |
| Ex. 10 | Tabular silver particle | A | A | UV absorbing layer | UV absorbing | 65.3 | 0.3 | C | A |
| | dispersion B6 | | | | layer | | | | |
| Ex. 11 | Tabular silver particle | A | A | Overcoat layer 4 | UV absorbing | 69.5 | 0.3 | A | A |
| | dispersion B1 | | | | layer | | | | |
| Ex. 12 | Tabular silver particle | A | A | Overcoat layer 5 | UV absorbing | 69.6 | 0.3 | A | A |
| | dispersion B1 | | | | layer | | | | |
| Ex. 13 | Tabular silver particle | A | A | Overcoat layer 6 | UV absorbing | 68.9 | 0.1 | A | A |
| | dispersion B1 | | | | layer and | | | | |
| | | | | | overcoat layer | | | | |
| Ex. 14 | Tabular silver particle | A | A | Overcoat layer 7 | UV absorbing | 69.0 | 0.1 | A | A |
| | dispersion B1 | | | | layer | | | | |
| Ex. 15 | Tabular silver particle | A | A | Adhesive layer | None | 70.3 | 58.7 | A | D |
| | dispersion B1 | | | | | | | | |
| Ex. 16 | Tabular silver particle | A | B | UV absorbing layer | UV absorbing | 70.0 | 0.3 | C | A |
| | dispersion B1 | | | | layer | | | | |
| Ex. 17 | Tabular silver particle | A | A | Overcoat layer 8 | Adhesive | 70.2 | 0.3 | A | A |
| | dispersion B1 | | | | layer | | | | |
| Comp. | Tabular silver particle | A | A | None | None | Not measured because of partial exfoliation of tabular | | | |
| Ex. 1 | dispersion B1 | | | | | metal particles | | | |
| Comp. | Tabular silver particle | B | A | UV absorbing layer | UV absorbing | 70.1 | 0.3 | D | A |
| Ex. 2 | dispersion B1 | | | | layer | | | | |
| Comp. | Tabular silver particle | A | A | UV absorbing layer | UV absorbing | 62.3 | 0.3 | D | A |
| Ex. 3 | dispersion B7 | | | | layer | | | | |

From the results shown in Table 2, the heat ray-shielding materials of the present invention are satisfactory in all of the evaluation results of the visible light transparency and the heat shielding capability (solar reflectance). It is considered that the addition of the surfactant C in a large amount reduces the surface tension to make the tabular metal particles float on the surface of the metal particle-containing layer; from Example 16, it has been found that when the tabular metal particles were not unevenly distributed close to the surface of the metal particle-containing layer, the evaluation of the heat shielding capability became approximately the same as the evaluations of the heat shielding capabilities in Examples 6 and 10 using the tabular silver particle dispersions B4 and B6, respectively.

From Comparative Example 1, it has been found that when no overcoat layer is disposed on the surface of the metal particle-containing layer including tabular metal particles, the tabular metal particles tend to be exfoliated and it is difficult to maintain the arrangement of the tabular metal particles. From Comparative Example 2, it has been found that when the arrangement of the tabular metal particles is unsatisfactory, the shielding capability is poor. From Comparative Example 3, it has been found that when the proportion of the tabular metal particles is low and the particle size distribution is wide, the shielding capability is poor.

It has also been found that the heat ray-shielding materials, each include an ultraviolet absorbing layer, of Examples 1 to 14, 16 and 17 are also satisfactory in degree of yellowness.

The aspects of the present invention are as follows.

<1> A heat ray-shielding material, including:

a metal particle-containing layer including at least one type of metal particles; and

an overcoat layer in close contact with at least one surface of the metal particle-containing layer,

wherein the metal particles include 60% by number or more of substantially hexagonal to substantially circular tabular metal particles, and

wherein principal planes of the substantially hexagonal to substantially circular tabular metal particles are plane-oriented within a range from 0° to ±30° on average in relation to one surface of the metal particle-containing layer.

<2> The heat ray-shielding material according to <1>, further including an adhesive layer.

<3> The heat ray-shielding material according to <1> or <2>, further including an ultraviolet absorbing layer containing at least one type of ultraviolet absorber.

<4> The heat ray-shielding material according to <3>, wherein the ultraviolet absorbing layer is either an overcoat layer or an adhesive layer.

<5> The heat ray-shielding material according to <2> or <3>, wherein the overcoat layer is an adhesive layer.

<6> The heat ray-shielding material according to any one of <1> to <5>, wherein with d representing the thickness of the metal particle-containing layer, 80% by number or more of the substantially hexagonal to substantially circular tabular metal particles are present within a range of d/2 from a surface of the metal particle-containing layer.

<7> The heat ray-shielding material according to any one of <1> to <5>, wherein 80% by number or more of the substantially hexagonal to substantially circular tabular metal particles are present within a range of d/3 from a surface of the metal particle-containing layer.

<8> The heat ray-shielding material according to <7>, wherein the overcoat layer is in close contact with the surface of the metal particle-containing layer which is closer to 80% by number or more of the substantially hexagonal to substantially circular tabular metal particles.

<9> The heat ray-shielding material according to any one of <1> to <8>, wherein an ultraviolet light transmittance of the heat ray-shielding material is 5% or less.

<10> The heat ray-shielding material according to any one of <1> to <9>, wherein a coefficient of variation in a particle size distribution of the substantially hexagonal to substantially circular tabular metal particles is 30% or less.

<11> The heat ray-shielding material according to any one of <1> to <10>, wherein an average particle diameter of the substantially hexagonal to substantially circular tabular metal particles is 70 nm to 500 nm, and an aspect ratio (average particle diameter/average particle thickness) of the substantially hexagonal to substantially circular tabular metal particles is 8 to 40.

<12> The heat ray-shielding material according to any one of <1> to <11>, wherein the tabular metal particles include silver.

<13> The heat ray-shielding material according to any one of <1> to <12>, wherein the visible light transmittance of the heat ray-shielding material is 70% or more.

<14> The heat ray-shielding material according to any one of <3> to <13>, wherein the ultraviolet absorber is at least one selected from the group consisting of a benzophenone-based ultraviolet absorber, a benzotriazole-based ultraviolet absorber and a triazine-based ultraviolet absorber.

<15> The heat ray-shielding material according to any one of <1> to <14>, further including a substrate on a surface of the metal particle-containing layer opposite to the surface of the metal particle-containing layer which is closer to 80% by number or more of the substantially hexagonal to substantially circular tabular metal particles.

<16> The heat ray-shielding material according to any one of <1> to <15>, further including a metal oxide particle-containing layer including at least one type of metal oxide particles.

<17> The heat ray-shielding material according to <16>, wherein the metal oxide particles are tin-doped indium oxide particles.

<18> A laminated structure, including:

the heat ray-shielding material according to any one of <1> to <17>; and

a sheet of either glass or plastic,

wherein the heat ray-shielding material and the sheet of either glass or plastic are laminated on each other.

### INDUSTRIAL APPLICABILITY

The heat ray-shielding material of the present invention is high in visible light transparency and solar reflectance, excellent in heat shielding capability, and capable of maintain the arrangement of tabular metal particles; and hence the heat ray-shielding material is suitably usable, for example, as films or laminated structures for vehicles such as automobiles and buses, films or laminated structures for building materials, and various members required to prevent the transmission of heat ray.

What is claimed is:

1. A heat ray-shielding material, comprising:
a metal particle-containing layer including at least one type of metal particles; and
an overcoat layer in close contact with at least one surface of the metal particle-containing layer,
wherein the metal particles comprise 60% by number or more of substantially hexagonal to substantially circular tabular metal particles, and
wherein principal planes of the substantially hexagonal to substantially circular tabular metal particles are plane-oriented within a range from 0° to ±30° on average in relation to one surface of the metal particle-containing layer.

2. The heat ray-shielding material according to claim 1, further comprising an adhesive layer.

3. The heat ray-shielding material according to claim 1, further comprising an ultraviolet absorbing layer containing at least one type of ultraviolet absorber.

4. The heat ray-shielding material according to claim 3, wherein the ultraviolet absorbing layer is either an overcoat layer or an adhesive layer.

5. The heat ray-shielding material according to claim 2, wherein the overcoat layer is an adhesive layer.

6. The heat ray-shielding material according to claim 1, wherein with d representing a thickness of the metal particle-containing layer, 80% by number or more of the substantially hexagonal to substantially circular tabular metal particles are present within a range of d/2 from a surface of the metal particle-containing layer.

7. The heat ray-shielding material according to claim 1, wherein 80% by number or more of the substantially hexagonal to substantially circular tabular metal particles are present within a range of d/3 from a surface of the metal particle-containing layer.

8. The heat ray-shielding material according to claim 7, wherein the overcoat layer is in close contact with the surface of the metal particle-containing layer which is closer to 80% by number or more of the substantially hexagonal to substantially circular tabular metal particles.

9. The heat ray-shielding material according to claim 1, wherein an ultraviolet light transmittance of the heat ray-shielding material is 5% or less.

10. The heat ray-shielding material according to claim 1, wherein a coefficient of variation in a particle size distribution of the substantially hexagonal to substantially circular tabular metal particles is 30% or less.

11. The heat ray-shielding material according to claim 1, wherein an average particle diameter of the substantially hexagonal to substantially circular tabular metal particles is 70 nm to 500 nm, and an aspect ratio (average particle diameter/average particle thickness) of the substantially hexagonal to substantially circular tabular metal particles is 8 to 40.

12. The heat ray-shielding material according to claim 1, wherein the tabular metal particles comprise silver.

13. The heat ray-shielding material according to claim 1, wherein a visible light transmittance of the heat ray-shielding material is 70% or more.

14. The heat ray-shielding material according to claim 3, wherein the ultraviolet absorber is at least one selected from the group consisting of a benzophenone-based ultraviolet absorber, a benzotriazole-based ultraviolet absorber and a triazine-based ultraviolet absorber.

15. The heat ray-shielding material according to claim 1, further comprising a substrate on a surface of the metal particle-containing layer opposite to the surface of the metal particle-containing layer which is closer to 80% by number or more of the substantially hexagonal to substantially circular tabular metal particles.

16. The heat ray-shielding material according to claim 1, further comprising a metal oxide particle-containing layer including at least one type of metal oxide particles.

17. The heat ray-shielding material according to claim 16, wherein the metal oxide particles are tin-doped indium oxide particles.

18. A laminated structure, comprising:
a heat ray-shielding material; and
a sheet of either glass or plastic,
wherein the heat ray-shielding material and the sheet of either glass or plastic are laminated on each other,
wherein the heat ray-shielding material comprises:
a metal particle-containing layer including at least one type of metal particles; and
an overcoat layer in close contact with at least one surface of the metal particle-containing layer,
wherein the metal particles comprise 60% by number or more of substantially hexagonal to substantially circular tabular metal particles, and
wherein principal planes of the substantially hexagonal to substantially circular tabular metal particles are plane-oriented within a range from 0° to ±30° on average in relation to one surface of the metal particle-containing layer.
